(19) United States
(12) Patent Application Publication
(10) Pub. No.: US 2006/0232077 A1
(43) Pub. Date: Oct. 19, 2006

(54) Lock release for motorized oven lock

(76) Inventors: Harry I. Courter, Indianapolis, IN (US); Vaughn C. Arens, Greenwood, IN (US)

Correspondence Address: Maginot, Moore & Beck LLP, Chase Tower, Suite 3250, 111 Monument Circle, Indianapolis, IN, 46204-5109, US

(21) Appl. No.: 11/105,628

(22) Filed: Apr. 14, 2005

(51) Int. Cl. E05C 3/06

(52) U.S. Cl. 292/201

(57) ABSTRACT

An oven lock mechanism has a latch that is moved between an unlatched and a latched position and a blocker that blocks the latch in the latched position when a cleaning cycle is initiated. The latch is mounted for movement relative to the blocker to facilitate disengaging the latch from the blocker.

### BACKGROUND AND SUMMARY

This invention relates generally to door locks for self-cleaning ovens and more particularly to door locks wherein the act of closing the oven door positions a latch in a position to lock the door and a blocking device secures the latch in that position when a self-cleaning cycle is initiated which latch is mounted to be disengaged from the blocking device.

A conventional gas or electric oven is subject to collecting deposits from whatever is placed in the oven to be cooked. Modern ovens are designed to self-clean upon demand by reducing these deposits to dust with high heat. This cleaning method is commonly known as pyrolytic cleaning. The high temperature used for pyrolytic cleaning poses a hazard if the oven door is opened during the cleaning cycle. To prevent this, an oven door lock is employed.

Many types of oven door locks have been provided that lock the oven door for a period sufficient to complete a pyrolytic cleaning cycle once initiated. Many of these door locks use electrical motors, electromechanical machines or manual manipulation of mechanisms to move a latch to a position in which the latch prevents the oven door from being opened during a self-cleaning cycle. Examples of such locks are disclosed in Phillips, U.S. Pat. No. 6,079,756; Thuleen et al., U.S. Pat. No. 4,082,078; McWilliams, III, U.S. Pat. No. 5,493,099; Smith, U.S. Pat. No. 6,302,098; Swartzell, U.S. Pat. No. 6,315,336; and Malone et al., U.S. Pat. No. 5,220,153. Another oven lock easily adaptable to incorporate the release mechanism disclosed herein is disclosed in co-pending U.S. patent application Ser. No. 10/730,296 (Attorney Docket No. 1007-0584), filed Dec. 8, 2003 entitled Motorized Oven Lock for Sealing Oven Door by Steve W. Smock, Harry I. Courter, Greg Wright and Tracy J. Talley, and U.S. patent application Ser. No. 10/730,475 (Attorney Docket No. 1007-0580), filed Dec. 8, 2003, entitled Motorized Oven Lock by Steve W. Smock, Harry I. Courter, Greg Wright and Tracy J. Talley. U.S. patent application Ser. Nos. 10/730,296 and 10/730,475 are both assigned to the same assignee as the present invention and the disclosures of both applications are hereby incorporated by reference in their entirety.

Often during or after a self cleaning cycle, the oven may experience a failure that prevents the latch from disengaging from the door. In the event of such a failure, technicians are often required to partially disassemble the oven, gain access to the oven lock through the rear of the oven or break the locking mechanism in order to open the oven door. While the necessity of using such procedures helps to ensure that the oven is not inadvertently opened during a cleaning cycle exposing the opener to the high temperatures therein or explosive combustion, oven owners and technicians would appreciate an oven lock that can be disengaged under certain circumstances including lock or an oven failure when the oven lock is in a locked position.

The disclosed oven lock mechanism moves a latch member between a latched and an unlatched position and uses an actuator to move a blocking member into a blocking position prohibiting the movement of the latch from the latched position to an unlatched position during a cleaning cycle. The disclosed oven lock mounts the latch and the blocker in a manner that facilitates moving the latch relative to the blocker when the blocker is in the blocking position to disengage the latch from the blocker in the event of an oven failure.

According to one embodiment, an oven door lock mechanism for use with an oven having a door and a frame configured so that the door is adjacent the frame when the door is closed includes a latch, an actuator, a blocker and a release mechanism. The latch is coupled to the frame for movement between an unlatched and latched position. The latch includes a latching member extending beyond the frame for interacting with the door. The blocker is coupled to the actuator. The blocker and actuator cooperate to move the blocker between a non-blocking position wherein the latch is free to move between the latched and unlatched position and a blocking position wherein the blocker blocks movement of the latch from the latched position to the unlatched position. The release mechanism is in operable engagement with the latch to move the latch, when the blocker is in the blocking position, to a disengaged position wherein the latch is disengaged from the blocker to enable the latch to move to the unlatched position.

According to another aspect of the disclosure, an oven lock mechanism for use with an oven having a door and a frame surrounding a cooking chamber having an opening selectively closed by engagement of the door with the frame includes a mounting plate, a latch, an actuator pin, a blocker, an electromechanical actuator and a release mechanism. The mounting plate is mounted to the frame. The latch is mounted to the mounting plate for movement about a pivot axis and is pivotable about the pivot axis between an unlatched and latched position. The latch includes a follower surface offset from the pivot axis. The actuator pin is movably supported by the mounting plate and includes an outer end extending beyond the mounting plate for engaging the oven door upon closure and a cam end engaging the follower surface for rotating the latch into the latched position wherein the door is adapted to be captured by the latch. The blocker is selectably moveable into a blocking position when the latch is in a latched position for interfering with the rotation of the latch such that the latch is blocked into the latched position for locking the oven door in a closed position. The electromechanical actuator is mounted to the mounting plate and urges the blocker into the blocking position when actuated. The release mechanism operably engages the latch to move the latch, when the blocker is in the blocking position, to a disengaged position wherein the latch is disengaged from the blocker to enable the latch to move to the unlatched position.

According to yet another aspect of the disclosure, an oven lock mechanism for use with a self-cleaning oven having a door for selectively closing an opening of a cooking compartment surrounded by a frame and a compressible seal includes a mounting plate, a latch, a blockable member, an actuator pin, a blocker, a motor and a release mechanism. The mounting plate is coupled to the frame near the oven compartment opening. The latch is pivotably mounted to the mounting plate about a pivot axis and is pivotable between an unlatched and latched position. The latch includes a follower surface offset from the pivot axis. The blockable member is mounted for movement relative to the mounting plate and is coupled to the latch so that when movement of the blockable member is blocked, movement of the latch from the latched to the unlatched position is inhibited. The actuator pin is movably supported by the mounting plate. The actuator pin includes an outer end extending beyond the mounting plate for engaging the oven door upon closure and a cam end engaging the follower surface for rotating the latch into the latched position wherein the door is adapted to be captured by the latch. The blocker is mounted for movement relative to the mounting plate to selectively block and unblock the blockable member. The motor is coupled to the mounting plate and when actuated moves the blocker. The release mechanism operably engages the latch to move the latch, when the blocker is in the blocking position, to a disengaged position wherein the blockable member is disengaged from the blocker to enable the latch to move to the unlatched position.

Additional features and advantages of the disclosed oven lock will become apparent to those skilled in the art upon consideration of the following detailed description of preferred embodiments exemplifying the best mode of carrying out the invention as presently perceived.

### BRIEF DESCRIPTION OF THE DRAWINGS

The illustrative devices will be described hereinafter with reference to the attached drawings which are given as non-limiting examples only, in which:

FIG. 1 is a perspective view of a self-cleaning oven with the oven door closed and an of the oven lock mechanism shown in phantom lines mounted at the front of the oven frame above the cooking chamber and below the cook top and showing grill openings located in the center of the oven through which the release mechanism shown in phantom lines is accessible utilizing an appropriate tool;

FIG. 2 is a bottom plan view with parts of the oven broken away of the oven lock mechanism and oven of FIG. 1 with the door of the oven open sufficiently to permit the latch of the oven lock mechanism to assume its normal unlocked position;

FIG. 3 is a plan view similar to FIG. 2 with the oven door closed resulting in the latch of the oven lock mechanism being urged into a latched position;

FIG. 4 is a plan view similar to FIG. 3 with the cam having rotated to pull the latch rearwardly with a predetermined pull-in force;

FIG. 5 is a plan view similar to FIG. 4 with the latch slid slightly forward to relieve excess pull-in force;

FIG. 6 is a plan view similar to FIG. 5 with the latch of the oven lock mechanism having been blocked in the latched position against returning to the unlatched position and the latch having been urged reward against the striker plate of the oven door to pull the oven door in toward the frame to compress the seal therebetween;

FIG. 7 is a plan view similar to FIG. 6 with the release mechanism having been actuated to move the latch to a disengaged position so that the latch of the oven lock mechanism is disengaged from the cam while the cam remains in the blocked position showing the latch having returned to the unlatched position;

FIG. 8 is a top plan view of the oven lock mechanism of FIG. 2;

FIG. 9 is a side elevation view taken along line 9-9 of the oven lock mechanism of FIG. 8;

FIG. 10 is a perspective view of the latch of FIG. 2;

FIG. 11 is a plan view of the latch of FIG. 10;

FIG. 12 is a side elevation view of the latch taken along line 12-12 of FIG. 11 with parts broken away;

FIG. 13 is a perspective view of the torque arm of FIG. 2;

FIG. 14 is a plan view of the torque arm of FIG. 13;

FIG. 15 is a sectional view of the torque arm taken along line 15-15 of FIG. 14;

FIG. 16 is a bottom plan view of the dual cam of FIG. 2;

FIG. 17 is a top plan view of the dual cam of FIG. 16;

FIG. 18 is a sectional view of the dual cam taken along line 18-18 of FIG. 17;

FIG. 19 is an exploded view of the release mechanism showing a latch release shaft, a slide bushing and a compression spring;

FIG. 20 is a side elevation view of the latch release shaft of FIG. 19;

FIG. 21 is a sectional view of the slide bushing of FIG. 19 taken through the longitudinal axis of the bushing;

FIG. 22 is a sectional view taken along line 22-22 of FIG. 6 of the oven lock mechanism showing the release mechanism in its normally biased position wherein the latch is urged into engagement with the torque arm and positioned so that the latch may be engaged by the cam to block the latch in the latched position;

FIG. 23 is a sectional view taken along line 23-23 of FIG. 7 of the oven lock mechanism showing the release mechanism having been actuated to move the latch longitudinally along the pivot axis relative to the cam to dispose the latch in the disengaged position wherein the latch is urged out of engagement with the torque arm and positioned so that the latch does not engage the cam so that the latch can be returned to the unlatched position while the cam remains in the blocked position;

FIG. 24 is a perspective view of the mounting plate of FIG. 2;

FIG. 25 is a plan view of the mounting plate of FIG. 24; and

FIG. 26 is a side elevation view of the mounting plate taken along line of 26-26 of FIG. 25.

### DETAILED DESCRIPTION OF THE DRAWINGS

The oven door lock mechanism 30 illustrated and described herein allows the closure of the door 12 to actuate rotational movement of a latch 32 about a pivot axis 216 into a position in which, if the latch 32 did not move, the oven door 12 could not open. Such a position is referred to herein as a latched position. In the illustrated oven lock mechanism 10, unless the latch 32 is blocked in the position that it assumes when the door 12 is closed, the process of opening the door 12 will result in movement of the latch 32 to a position that will not inhibit door 12 from opening, i.e. an unlatched position. The latch 32 is selectively blocked in the latched position in response to an indication that a cleaning cycle is to begin. An actuator moves a blocker into a blocking position to block the latch in the latched position. Illustratively, the blocking is accomplished by a motor, acting as the actuator, rotating a cam 46, acting as the blocker, into the blocking position. When the latch 32 is in the latched position and the cam is in the blocking position, the latch is in a blocked engaged position. In the blocked engaged position the cam 46 is in engagement with the latch 32 or in a position in which rotational movement of the latch 32 will induce engagement between the cam 46 and the latch 32 when the latch is in its normally biased position longitudinally relative to the pivot axis 216.

The disclosed release mechanism 36 facilitates movement of the latch 32 longitudinally along the pivot axis 216 relative to the cam 46 to a position wherein the latch 32 will not engage and be blocked by the cam 46 while the cam 46 is in the blocking position during rotational movement of the latch 32 to the unlatched position, i.e. the disengaged position. In the illustrated embodiment, the latch 32 is moved vertically downwardly relative to the cam 46 so the latch 32 is positioned below the cam 46.

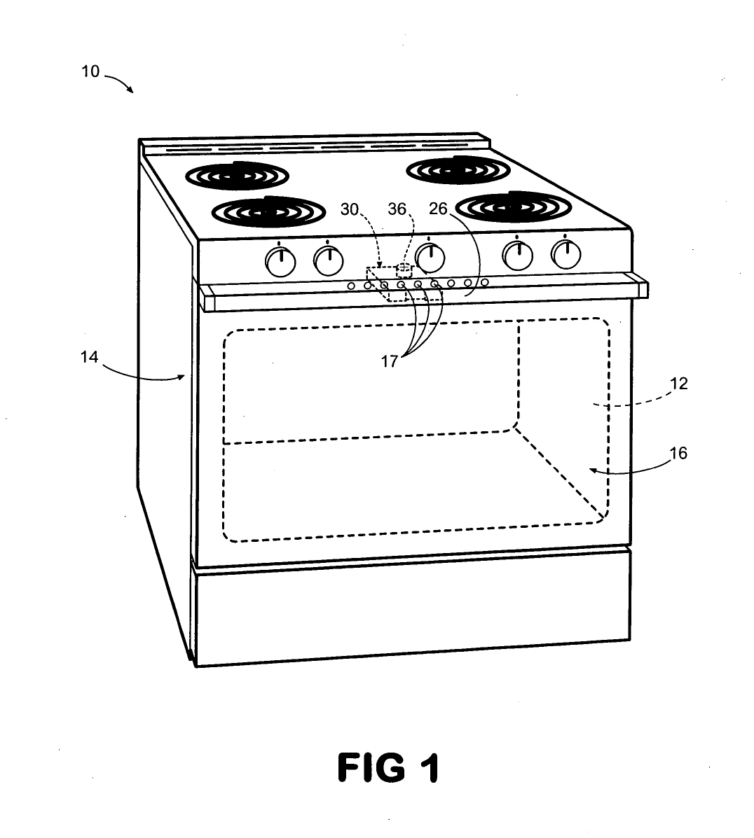

As shown, for example, in FIG. 1, the illustrated embodiment of the oven lock mechanism 30 is configured for mounting in a self cleaning oven 10. The oven 10 includes a door 12 hinged at its bottom to a frame 14. The frame 14 of the oven 10 is disposed about an oven chamber 16. A cook top 18 is coupled to the frame and disposed above the oven chamber 16. Grill openings 17 are located in the front center of the oven 10 above the oven chamber 16. The release mechanism 36 of the oven lock 30 is accessible through the grill openings 17 utilizing an appropriate tool.

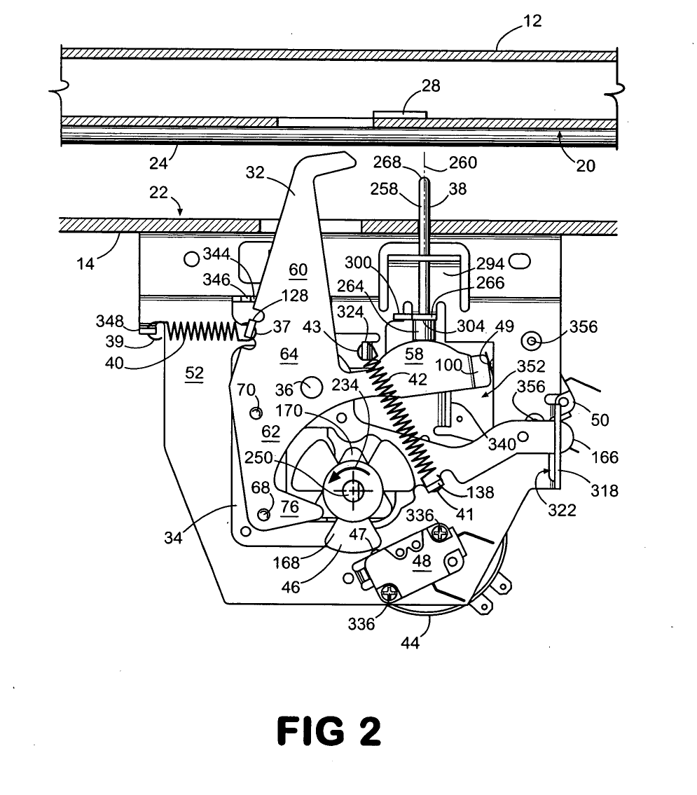

The door 12 closes at an interface formed by an inner face 20 (FIG. 2) of the door 12 and an abutment surface 22 of the oven frame 14. As shown, for example, in FIGS. 2-4, inner face 20 of oven door 12 is provided with a seal 24 for engaging the abutment surface 32 of the frame 14 providing for a sealed oven chamber 16. Those skilled in the art will recognize that alternatively, the abutment surface 22 of the frame 14 may be provided with a seal for engaging the inner face 20 of the oven door 12. The disclosed embodiment of the oven door lock mechanism 30 is mounted at the top 26 of the frame 14 of the oven 10 just under the cook top 18 out of sight except through the grill openings 17.

As shown for example in FIG. 2, the illustrated oven lock mechanism 30 includes a latch 32, a torque arm 34, a release mechanism 36, an actuator pin 38, a latch bias spring 40, a torque arm bias spring 42, a motor and gear box 44, a dual cam 46, a cam-actuated switch 48, a latch-actuated switch 50 and a mounting plate 52.

The ends of the actuator pin 38 and latch 32 are exposed forward at the abutment surface 22 of the frame 14 that interfaces with the inside face 20 of the oven door 12. When the oven door 12 is closed, the inside face 20 of the door 12 engages and depresses the actuator pin 38. The depressed actuator pin 38 depresses against the latch 32 and rotates the latch 32 to a position that traps the door 12. The switch 50 is activated by rotation of the latch 32 to the latched position. Activation of the switch 50 enables the self-cleaning function. If self-cleaning is selected, typically by user actuation of a switch on the oven control panel, a circuit is closed driving the motor and gear box 44 to rotate the dual cam 46. The cam 46 rotates to a position that traps the latch 32 in a blocked position. Rotation of the cam 46 induces a change of state of the cam-actuated switch 48. The cam-actuated switch 48 controls the proper position of the cam lobes. The cam-actuated switch 48 also signals to an electronic package a change in state. Such electronic packages for locking out motor movement during a self-cleaning cycle are well known. Examples of such electronics packages are disclosed in Gilliom, U.S. Pat. No. 3,859,979 and Barnett, U.S. Pat. No. 4,374,320, the disclosures of which are incorporated herein by this reference.

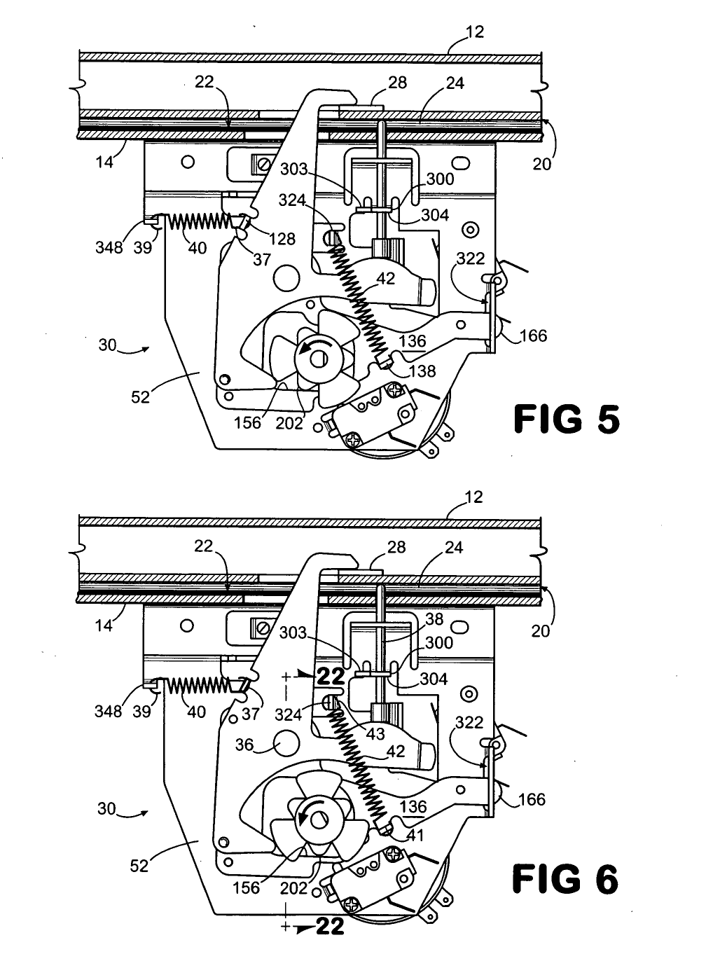

As shown, for example, in FIGS. 2-6, the actuator pin 38 of the oven lock mechanism 30 is moved against a bias exerted by the latch bias spring 40 to a depressed position every time the oven door 12 is closed. In response to this action, the latch 32 is advanced into a latched position regardless of whether or not the oven 10 is to be placed in a self-cleaning mode of operation. When a user does place the oven 10 in the self-cleaning mode, an oven controller actuates the motor and gear box 44 to drive the dual cam 46 that acts as a block out member or blocker to a blocking position. When the cam 46 is placed in the blocking position and the cam 46 and latch 32 are in an engagement position relative to one another, any attempt to open the oven door 12 will be unsuccessful since the block out member 46 is positioned to prevent the latch 32 from pivoting back to its unlatched position. Once the self-cleaning cycle is completed, the oven controller actuates the motor and gear box 44 to drive the dual cam 46 back to a non-blocking position. When placed in such non-blocking position, an attempt to open the oven door 12 is successful since the cam 46 is positioned to allow the latch 32 to freely pivot back to its unlatched position.

If a user or technician desires to open the oven door 12 while the cam 46 is in the blocking position and the latch 32 is in the latched position, the release mechanism 36 permits the latch 32 to be moved relative to the cam 46 to a disengaged position whereby the latch 32 can be rotated to the unlatched position without being blocked by the cam 46 even though the cam 46 remains in the blocking position. In the illustrated embodiment, the release mechanism 36 is configured to move the latch 32 perpendicular to the plane of rotation of the cam 46 relative to the cam 46 to induce the latch 32 and cam 46 to become disengaged.

The mounting plate 52 of the oven lock mechanism 30 is mounted to the oven frame 14. The oven lock mechanism 30 is positioned relative to the frame 14 so that the latching arm 60 of the latch 32 and the rounded end 268 of the shaft 258 of the actuator pin 38 extend forwardly beyond the abutment surface 22 of the oven frame 14 when the oven door 12 is opened. This is to permit the oven door 12 to engage the rounded end 268 of the actuator pin 38 during closing to urge the pin 38 to reciprocate rearwardly to urge the latch 32 into a latching position.

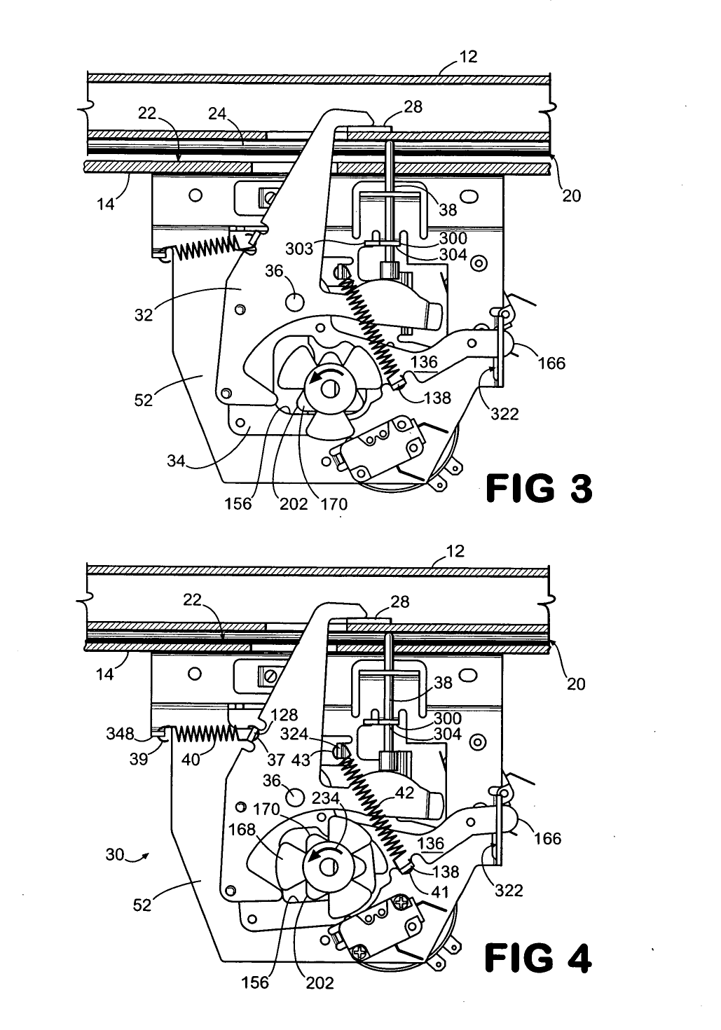

As shown, for example, in FIGS. 2-10, the latch 32 is mounted to the torque arm 34 for pivotal movement about the pivot axis 216 (FIGS. 9, 22, 23) for movement between the latched position and an unlatched position. The torque arm 34 is mounted to the mounting plate 52 for reciprocal forward and rearward movement. As the torque arm 34 moves forwardly and rearwardly, the latch 32 pivotally mounted thereto also reciprocates forwardly and rearwardly between a non-cleaning latched position (FIG. 3) and a cleaning latched position (FIG. 6) or pulled-in position.

The mounting plate 52 is rigidly mounted to the oven frame 14. The motor and gear box 44 are mounted to the mounting plate 52 so that its shaft 250 extends through the motor shaft-receiving hole 326 in the mounting plate 52. The dual cam 46 is mounted to the shaft 250 so that the triangular cam 170 is received in the cam-receiving aperture 150 defined in the main body 134 of the torque arm 34 and the three lobed cam shaft 168 is positioned to engage the blockable arm 62 of the latch 32 upon rotation of the motor and gear box 44.

When the oven door 12 is open, or when the door 12 is closed and a cleaning cycle has not been initiated, one side wall 200 of the triangular cam 170 is substantially parallel to the abutment surface 22 of the oven frame 14 as shown, for example, in FIGS. 2 and 3. This side wall 200 is in engagement with the flat rear follower wall 156 of the cam-receiving aperture 150 in the torque arm 34. The torque arm bias spring 42 urges the torque arm 34 and the latch 32 forward so that the flat follower surface 156 is biased against the side surface 200 of the triangular cam 170. Due to the arrangement of triangular cam 170 and three lobed cam 168, when the triangular cam 170 is so positioned, the three lobed cam 168 is positioned in a non-blocking position such that none of the lobes 178 interferes with rotational movement of the latch 32 and the blocked member 76 is free to pivot into and out of a void 194 between two of the cam lobes 178.

When the door 12 closes, the inner face 20 of the door 12 engages the rounded end 268 of the shaft 258 of the actuator pin 38 and urges the actuator pin 38 rearwardly. The cam surface 262 on the head 256 of the actuator pin 38 is pushed against the arcuate follower surface 98 of the follower arm 58 of the latch 32 inducing clockwise (as seen from the bottom, as shown, for example, in FIGS. 2-8) rotation of the latch 32 about the release mechanism 36 causing the latch bias spring 40 to be stretched to store a restorative force for returning the latch 32 to an unlatched position. Clockwise rotation of the latch 32 accomplishes at least three things, as shown, for example, in FIG. 3. First, the latching arm 60 is pivoted to within a slot in the door 12 of the oven 10 to a position in which the engaging wall 124 of the latching member 120 is adjacent to a striker plate 28 in the oven door 12. In this position, the latch 32 would prohibit outward movement of the door 12. Second, the blocked member 76 of the blockable arm 62 is pivoted out of one of the sixty degree voids 194 between lobes 178 of the three-lobed cam 168 of the dual cam 46. Third, the offset switch actuator arm 100 at the end of the follower arm 58 of the latch 32 is moved to a position in which it no longer engages the motor electrical actuator switch 50. Other methods of actuating the switch 50 are within the scope of the disclosure, including, but not limited to, configuring the actuator pin to both rotate the latch 32 and actuate the switch 50 upon door closure.

When the contact button 49 is actuated during door closure, switch 50 permits current flow to the motor and gear box 44. Thus, movement of the latch 32 into the latched position enables the motor and gear box 44 which may then move the cam 46 to a blocking position upon receipt of a signal initiating a cleaning cycle. When in the blocking position, the block out member, blocker or camming surface 188 of one of the three lobes 178 of the dual cam 46 engages the follower surface 80 on the end of the blocked member 76 of the blockable arm 62 of the latch 32 preventing counter-clockwise rotation of the latch 32 at least so long as the latch 32 is in the plane of rotation of the cam 46.

Not only does the disclosed oven lock mechanism 30 block the latch 32 from rotating from a latched position to an unlatched position after a cleaning cycle initiation signal has been received, but it also moves the latch 32 into a pulled-in position. In this pulled-in position the gasket or seal 24 disposed between the inner face 20 of the oven door 12 and the abutment surface 22 is compressed as the door 12 is pulled into a more snug engagement with the abutment surface 22. The triangular cam 170 as it turns sixty degrees brings a rounded corner 202 of the triangular cam 170 into engagement with the rear cam-follower wall 156 of the cam-receiving aperture 150 of the torque arm 34 forcing the torque arm 34, latch 32 and release mechanism 36 to move rearwardly with respect to the mounting plate 52. During this rearward movement, the release mechanism 36 slides rearwardly within the slot 306 in the mounting plate 52. Also, the engaging wall 124 of the latch 32 engages the striker plate or inner wall 28 of the oven door 12 and pulls the oven door 12 rearwardly causing the seal 24 to be compressed between the oven door 12 and the abutment surface 22 of the frame 14.

As shown, for example, in FIG. 6, after the dual cam 46 rotates sixty degrees, the lobe 178 previously actuating the contact button 47 of the cam-actuated switch 48 rotates to a position in which the contact button 47 is released. Upon release of the contact button 47, a timer circuit (not shown) is initiated and further rotation of the motor and gear box 44 and the cam 46 attached thereto is locked out until the timer expires indicating the end of the cleaning cycle.

At the end of the cleaning cycle in which neither the oven 10 nor the oven lock mechanism 30 have experienced a failure, the cam 46 again rotates sixty degrees permitting the torque arm 34 to be returned to its normally biased forward position. During movement of the torque arm 34 to its forward position, engaging wall 124 of latching arm 60 moves forward and out of engagement with the striker plate or inside surface 28 of the oven door 12. The three lobed cam 168 moves to a position in which the follower surface 80 of the blockable arm 62 of the latch 32 is no longer in engagement with the camming surface 188 of one of the lobes 178 of the three-lobed cam 168. The blocked member 76 is no longer blocked from moving counter-clockwise into a sixty degree void 194 between lobes 178, however, the actuator pin 38 continues to engage the follower surface 98 of the follower arm 58 of the latch 32 overcoming the attempts of the bias spring 40 to return the latch 32 to the unlatched position. When the door 12 is pulled open and the door springs (not shown) are no longer forcing the oven door 12 against the actuator pin 38, the latch bias spring 40 induces counter-clockwise rotation of the latch 32 causing the latch 32 to return to the unlatched position.

The oven lock mechanism 30 is provided with the release mechanism 36 in the event of a failure of the oven 10 or oven lock mechanism 30 while the latch 32 is in the latched position and the cam 46 is in the blocking position. The disclosed release mechanism 36 is described as being used with an oven lock mechanism 30 very similar to that disclosed in the incorporated co-pending U.S. patent application Ser. Nos. 10/730,296 and 10/730,475 assigned to the same assignee as the present invention. The disclosed release mechanism 36 replaces the slide pin (numbered 36 in U.S. patent application Ser. Nos. 10/730,296 and 10/730,475) of the incorporated patent applications. The disclosed release mechanism is configured to serve all of the same functions as the slide pin in the incorporated patent applications.

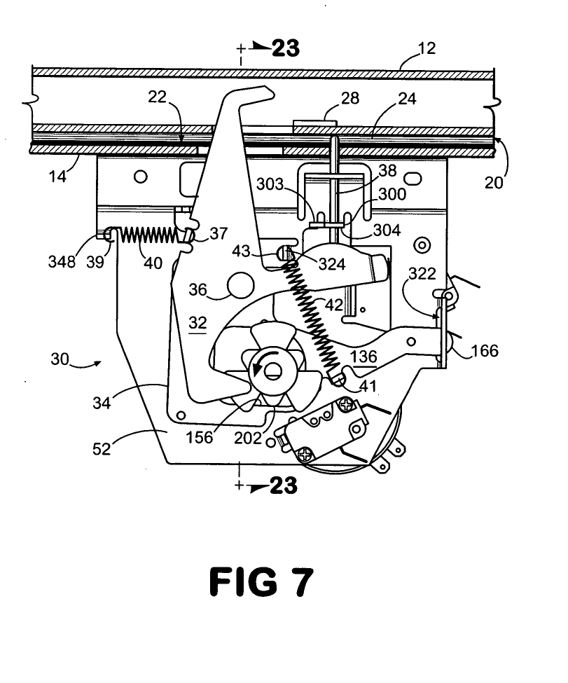

Additionally, the release mechanism 36 is configured to move the latch 32 longitudinally along the pivot axis 216 relative to the cam 46 and the actuator pin 38 to disengage the latch 32 from the cam 46 and the actuator pin 38 when actuated. When the latch 32 is moved longitudinally along the pivot axis 216 relative to the cam 46 and the actuator pin 38 to be disengaged from both components, the latch bias return spring 40 is free to return the latch 32 to an unlatched displaced position as shown for example in FIGS. 7 and 23. Those skilled in the art will recognize that it is not necessary for latch 32 to be disengaged from actuator pin 38 for release mechanism 30 to permit the oven door 12 to be opened when the cam 46 is in the blocking position. In the illustrated oven lock mechanism 30, the operation of pulling on the door 12 will induce the spring loaded actuator pin 38 to move allowing the latch 32 to rotate to the unlatched position so long as the latch 32 is positioned to avoid engagement with the cam 46.

In the illustrated embodiment, the release mechanism 36 includes a latch release shaft 207, a slide bushing 209 and a compression spring 211. The release shaft 207 is formed concentrically about a longitudinal axis 218 that serves as the pivot axis 216 and includes a shaft portion 213, a head 215 at one end of the shaft portion 213 and a latch portion 214 at the other end of the shaft portion 213.

The shaft portion 213 has an outside diameter 217. The outside diameter 217 of the shaft portion 213 is such that the shaft portion 213 is sized to be received in the cylindrical cavity 227 of the slide bushing 209 for longitudinal movement relative to the slide bushing 209 along the longitudinal axis 218 and pivot axis 216. The head portion 215 is disk-shaped and has an outside diameter 219 greater than the outside diameter 217 of the shaft portion 213 so that a flange 221 is formed at the first end of the shaft portion 213.

The latch portion 214 is cylindrical and has a length 223 slightly greater than the thickness of the latch 32. The latch portion 214 has an outside diameter 230 less than the outside diameter 217 of the shaft portion 213 and slightly less than or approximately equal to the inside diameter of the pivot pin-receiving hole 66 in the latch 32. A ring-shaped lip 232 extends radially inwardly between the outer surfaces of the shaft portion 213 and the latch portion 214. In the illustrated embodiment, the latch portion 214 is received in the pivot pin-receiving hole 66 of the latch 32 and the latch release shaft 207 is staked to the latch 32. Thus the upper surface 74 of the latch 32 engages the lip 232 of the latch release shaft 207 while the lower surface 72 of the latch 32 engages the deformed second end of the latch portion 214 to secure the latch 32 to the latch release shaft 207.

While the disclosed embodiment couples the latch 32 to the latch release shaft 207 by staking the latch release shaft 207 to the latch 32, it is within the scope of the disclosure for the latch release shaft 207 to be coupled to the latch 32 in other manners. For instance, a fastener, such as a screw, can be utilized to secure the latch 32 to the latch release shaft 207 to permit removal of the latch 32 from the latch release shaft 207 for repair or replacement of the components of the oven lock mechanism 30. Other commonly known means of securing a plate to a pin, including, but not limited to, welding, brazing or bonding, may be used to secure the latch 32 to the latch release shaft 207 within the scope of the disclosure.

The slide bushing 209 is formed concentrically about a longitudinal axis 225, which when the slide bushing 209 is mounted to the mounting plate 52 coincides with the pivot axis 216. The slide bushing 209 includes a tubular body portion 212 and a ring-shaped head portion 210 coupled to one end of the body portion 212. Body portion 212 and head portion 210 are formed to define a cylindrical aperture 227 extending longitudinally through the slide bushing 209. The cylindrical aperture 227 has an inside diameter 229 slightly greater than the outside diameter 217 of the shaft portion 213 of the latch release shaft 207 to facilitate the shaft portion 213 of the latch release shaft 207 being received therein for longitudinal reciprocal movement relative to the slide bushing 209.

The head portion 210 of the slide bushing 209 has an outside diameter 220 greater than the outside diameter 231 of the body portion 212 and greater than the width 308 of the slide slot 306 of the mounting plate 52. A lip wall 226 extends radially inwardly from the cylindrical side wall of the head portion 210 to the cylindrical outer wall of the body portion 212. The lip wall 226 acts as a stop that engages the upper surface 272 of the mounting plate 52 adjacent the slide slot 306. The cylindrical outer wall of the body portion 212 of the slide bushing 209 has a length 228 and an outside diameter 231. The length 228 is slightly less than the combined thickness of the mounting plate 52, the thickness of the torque arm 34, the length of the bosses 140, 142, 144, 146 extending from the torque arm 34 and the length of the bosses 68, 70 extending from the latch 32. The outside diameter 231 of the body portion 212 is slightly less than the width 308 of the slot 306 in the mounting plate 52 and the inside diameter of the pivot pin-receiving hole 148 in the torque arm 34. The length 228 and diameter 231 of the body portion 212 permit the body portion 212 to extend through the slot 306 in the mounting plate 52 and the pivot pin-receiving hole 148 in the torque arm 34 so that the distal end of the slide bushing 209 is in engagement with upper surface 74 of the latch 32. The lip 226 of the slide bushing 209 rides on the upper surface 272 of the mounting plate 52 adjacent the slot 306 as the release mechanism 36 slides longitudinally within the slot 306 during pull-in of the oven door 12.

The spring 211 is a helical spring having an inner passage 233 extending therethrough sized to permit the shaft portion 213 of the release shaft 207 to extend therethrough. The flange wall 221 of the head 215 of the release shaft 207 and the proximal wall 235 of the head 210 of the slide bushing 209 act as seats against which opposite ends of the spring 211 act to bias the latch 32 in an engageable position, wherein the blocker can engage the latch 32 to block the latch 32 in the blocked position.

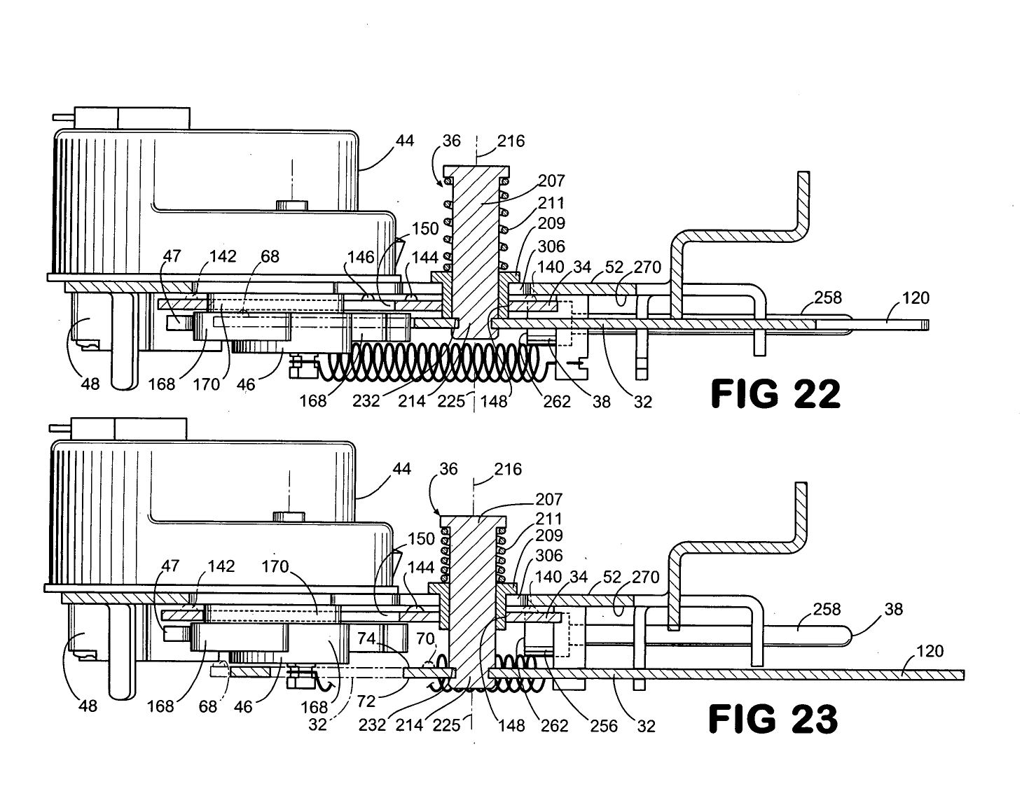

As shown, for example, in FIGS. 9 and 22, the spring 211 of the release mechanism 30 acts to bias the release mechanism 36 to position the latch 32 in an engageable position that is similar to the position of the latch 32 in the incorporated patent applications. The spring 211 pushes against the flange 221 of the head 215 of the latch release shaft 207 and the proximal wall 235 of the head 210 of the slide bushing 209 to urge the head 215 of the latch release shaft 207 away from the head 210 of the slide bushing 209. Because the release shaft is staked to the latch 32, the latch 32 is pulled by the force of the spring 211 into a position in which the bosses 68, 70 of the latch 32 engage the bottom surface 130 of the torque arm 34. The spring 211, release shaft 207 and latch 32 cooperate to pull the bosses 140, 142, 144, 146 on the torque arm 34 into engagement with the bottom surface 270 of the mounting plate 52. When the release mechanism 30 is in its normally biased position, the latch 32, torque arm 34, mounting plate 52 and cam 46 are positioned relative to each other just like they are positioned in the oven lock mechanism disclosed in the incorporated patent applications. Thus, when the release mechanism 30 is in its normally biased position, the disclosed oven lock mechanism 30 operates in the same manner as the oven lock disclosed in the incorporated patent applications.

In the event of a failure of the oven or oven lock mechanism 30 when the cam 46 is in the blocking position and the latch 32 is in a latched and blocked position, the release mechanism 36 can be actuated to disengage the latch 32 from the cam 46 to permit the latch 32 to be returned to the unlatched position, as shown, for example, in FIGS. 7 and 23. A tool, such as a screw driver or another tool designed according to the specific oven configuration, is inserted through the grill openings 17 in the front of the oven to engage the head 215 of the latch release shaft 207 of the release mechanism 36. The latch release shaft 207 is then depressed to move the shaft 207 downwardly along the pivot axis 216 and compress the spring 211 between the release shaft 207 and the slide bushing 209.

Downward movement of the release shaft 207 relative to the slide bushing 209, actuator pin 38, mounting plate 52 and cam 46 induces movement of the latch 32 attached to the release shaft 207 relative to the actuator pin 38, mounting plate 52 and cam 46. The disclosed release shaft 207 and spring 211 are configured and designed to permit the latch 32 to be moved sufficiently downward along the pivot axis 216 so that the latch 32 becomes disengaged from both the cam 46 and the actuator pin 38. When the release mechanism 36 is in its actuated position, the latch 32 is in a disengaged position wherein it is free to rotate about pivot axis 216 to an unlatched position to permit the oven door to be opened even though the cam 46 remains in the blocked position. Thus, the release mechanism 36 facilitates movement of the latch 32 to a position in which it is not blocked from moving to an unlatched position even though the blocker is in the blocking position.

The manner of operation of the oven lock mechanism 30 can be understood better by understanding the configuration and interaction of the various components of the oven lock mechanism 30. These components are designed and configured to facilitate the above described manner of operation of the oven lock mechanism 30. Understanding of the oven lock mechanism 30 is facilitated by recognizing that the mechanism 30 is mounted to the frame 14 of the oven 10 so that the motor and gear box 44 extend upwardly from the mounting plate 52. Thus, FIGS. 2-8 depict the oven lock mechanism 30 as viewed from the bottom looking up. As previously mentioned, the oven lock mechanism 30 includes a latch 32, a torque arm 34, a release mechanism 36, an actuator pin 38, a latch bias spring 40, a torque arm bias spring 42, a motor and gear box 44, a dual cam 46, a cam-actuated switch 48, a latch-actuated switch 50 and a mounting plate 52.

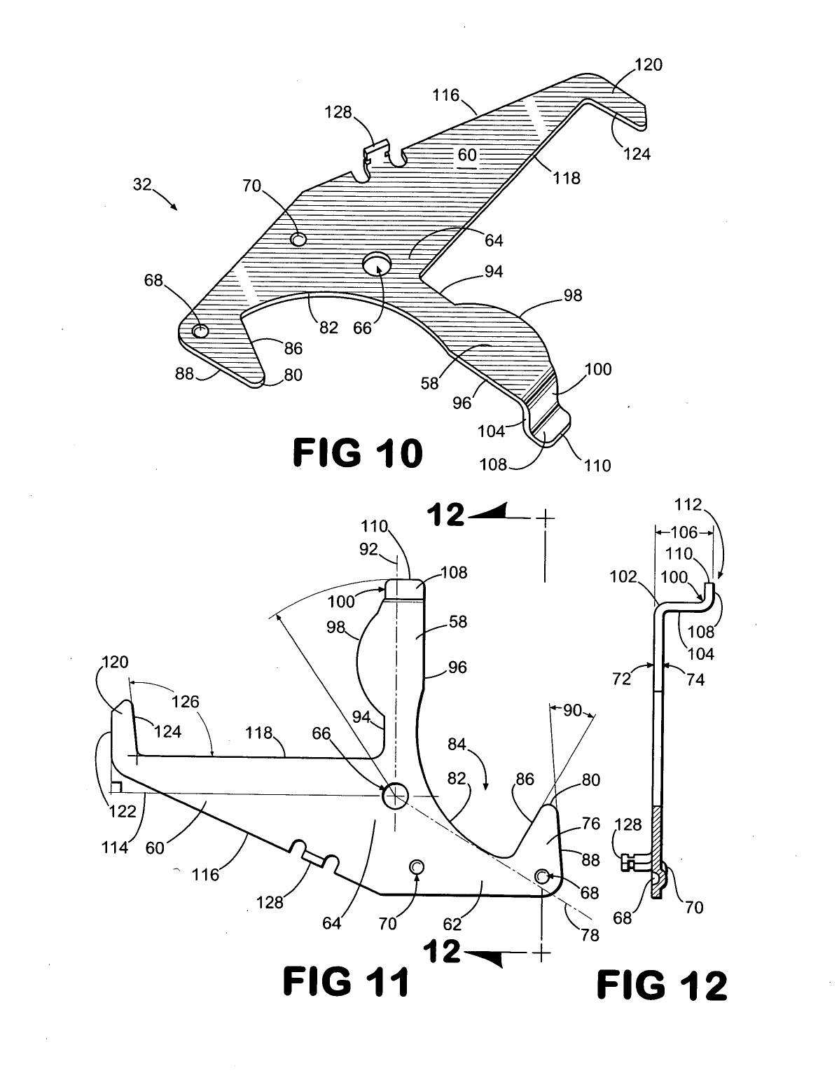

The latch 32 is configured to facilitate being rotated into a latched position by closure of the oven door 12 and being blocked in that position when the release mechanism 36 is in its normally biased position. As shown, for example, generally in FIGS. 2-9, and more particularly in FIGS. 10-12, latch 32 includes a follower arm 58, a latching arm 60 and a blockable arm 62 all extending generally radially from a central body 64 formed to include a pivot pin-mounting hole 66. Pivot pin-mounting hole 66 is sized to receive the latch portion 214 of the release shaft 207 of the release mechanism 36 therein. The latch 32, except for an offset switch actuator arm 100 at the distal end 102 of the follower arm 58, dimples 68, 70 and a spring anchor finger 128, is substantially planar having a bottom surface 72 and a top surface 74

Latch 32 is configured to pivot about a pivot axis 216 extending through the release mechanism 36. The latch 32 is mounted for pivotal movement relative to the torque arm 54 and the mounting plate 52. Since, as explained further hereafter, release mechanism 36 moves in a reciprocal fashion forwardly and rearwardly with respect to the mounting plate 52, the latch 32 moves forwardly and rearwardly with respect to the mounting plate 52. Since the latch 32 and the torque arm 34 are both mounted to the release mechanism 36, latch 32 rotates about a fixed pivot axis 216 with respect to the torque arm 34. Such pivot axis 216 is not however, fixed with respect to the mounting plate 52.

Generally, the main body 64 and the blockable arm 62 of the latch 32 are mounted so that they are positioned below portions of the torque arm 34. During formation of the latch 32, dimples 68, 70 are stamped or otherwise formed in the blockable arm 62 and the main body 64, respectively, of the latch 32. As shown, for example, with respect to the dimple 68 in FIG. 12, each dimple 68, 70 forms a pit extending into the bottom surface 72 of the latch 32 and forms a boss extending outwardly from the top surface 74 of the latch 32. The bosses of dimples 68, 70 ride on the lower surface 130 of the torque arm 34 during rotation of the latch 32 with respect to the torque arm 34 to aid in reducing friction between the two when the release mechanism 36 is in its normally biased position urging the latch 32 into engagement with the torque arm 34.

Bosses of dimples 68, 70 also tend to aid in maintaining the substantially parallel relationship between the top surface 74 of the latch 32 and the lower surface 130 of the torque arm 34 when the release mechanism 36 is in its normally biased position urging the latch 32 into engagement with the torque arm 34. Additionally, the bosses of the dimples 68, 70 help to maintain a horizontal separation between the latch 32 and the torque arm 34 so that the latch 32 engages only the lower three lobed cam 168 and the torque arm 34 engages only the upper triangular cam 170 of the dual cam 46 when the release mechanism 36 is in its normally biased position urging the latch 32 into engagement with the torque arm 34.

The blockable arm 62 is formed to include a blocked member 76 extending laterally with respect to an axis 78 extending through the blockable arm 62 and the mounting hole 66. The blocked member 76 includes a rounded follower surface 80 at its lateral extreme surface. Blocked member 76 extends generally laterally outwardly from a concave arcuate clearance surface 82 formed in portions of the blockable arm 62 and portions of the rear surfaces of the main body 64 and follower arm 58. The clearance surface 82 is provided to permit a lobe 178 of the three lobed cam 168 of the dual cam 46 to extend into the void 84 between the blocked member 76 and the follower arm 58 as shown, for example, in FIG. 2.

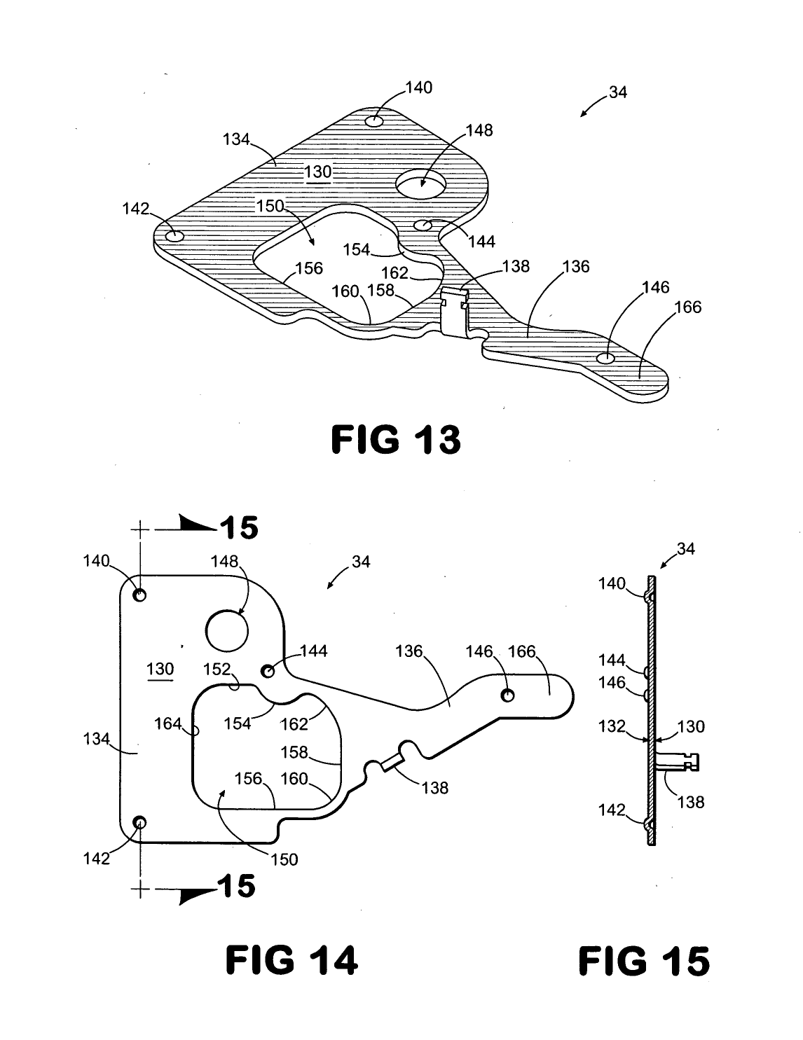

Blocked member 76 includes front wall 86 and rear wall 88 extending laterally inwardly from axis 78 and meeting at the rounded follower surface 80 to form an angle 90 therebetween, as shown, for example, in FIG. 13. In the illustrated embodiment, the angle 90 between the front wall 86 and the rear wall 88 of the blocked member 76 is approximately thirty-five degrees. The shape of the blocked member 76 permits the blocked member 76 to extend into a void 194 between each two lobes 178 of the three lobed cam 168 of the dual cam 46 when the latch 32 is in an unlatched position and the release mechanism 36 is in its normally biased position urging the latch 32 into engagement with the torque arm 34, as shown, for example, in FIG. 2.

The follower arm 58 of the latch 32 includes an axis 92, a front surface 94, a rear surface 96, an arcuate follower surface 98 and an offset switch actuator arm 100. The axis 92 of the follower arm 58 extends radially outwardly from the pivot pin-mounting hole 66. The front surface 94 and the rear surface 96 of the follower arm 58 are generally parallel, except in the region of the arcuate follower surface 98 and arcuate clearance surface 82, to the axis 92. Convex arcuate follower surface 98 extends forwardly from front surface 94 of the follower arm 58. In the illustrated embodiment, follower surface 94 has a radius of curvature centered on the rear surface 96 of the follower arm 58. Arcuate follower surface 98 provides a surface for cam surface 262 of the actuator pin 38 to bear against when the release mechanism 36 is in its normally biased position urging the latch 32 into engagement with the torque arm 34. Thus, inward rectilinear movement of the actuator pin 38 induces the follower arm 58 to be urged to rotate clockwise about pivot axis 216 when the release mechanism 36 is in its normally biased position urging the latch 32 into engagement with the torque arm 34.

The offset switch actuator arm 100 is an L-shaped arm extending upwardly and outwardly from the distal end 102 of the follower arm 58. The upwardly-extending leg 104 has a length 106 sufficient to permit L-shaped arm to extend through an aperture 352 in the mounting plate 52. The outwardly-extending arm 108 extends outwardly from the top of upwardly-extending arm 104. A switch actuator surface 110 on the outer end 112 of the outwardly-extending arm 108 is curved with a radius of curvature centered at the focus of the pivot pin-mounting hole 66. Thus, so long as the switch actuator surface 110 remains in contact with the contact button 49 of the switch 50 during rotation of the latch 32, the switch actuator surface 110 applies a constant force to the contact button 49. When the oven door 12 is closed, as shown, for example, in FIG. 3, the follower arm 58 is rotated sufficiently so that switch actuator surface 110 does not engage the contact button 49. It is within the scope of the disclosure for the actuator pin to be configured to actuate switch 50 permitting the latch to be formed without the offset switch actuator arm 100.

The latching arm 60 of the latch 32 includes an axis 114, an outside wall 116, an inside wall 118, and a latching member 120. The axis 114 of latching arm 60 extends radially from the pivot pin-mounting hole 66. In the illustrated embodiment, the axis 114 of the latching arm 60 is perpendicular to the axis 92 of the follower arm 58. As shown, for example, in FIG. 11, the inside wall 118 is parallel to the axis 114 of the latching arm 60. The latching arm 60 tapers as it extends forward resulting in the outside wall 116 forming an angle with the axis 114. The latching member 120 includes an end wall 122 and an engaging wall 124. The engaging wall 124 extends inwardly and slightly forwardly from inside wall 118 at an angle 126. In the illustrated embodiment, angle 126 is ninety-seven degrees. The angle 126 between the inside wall 118 and the engaging wall 124 is formed to cause the engaging wall 124 to be substantially parallel with the striker plate 28 in the oven door 12 when the latch 32 is in its latched position.

Near the junction of the latching arm 60 and the main body 64 of the latch 32, a latch bias spring anchor finger 128 extends downwardly from the bottom surface 72 of the latch 32. Spring anchor finger 128 is formed to include notches therein for receipt of the latch end 37 of the latch bias spring 40. Latch bias spring 40 biases the latch 32 toward the unlatched position.

As shown, for example, in FIGS. 13-15, the torque arm 34 includes a lower surface 130, an upper surface 132, a main body 134 and a cantilevered arm 136. In the illustrated embodiment, except for the downwardly extending spring anchor finger 138 and the plurality of dimples 140, 142, 144, 146, the lower surface 130 and the upper surface 132 of the torque arm 34 are substantially planar and parallel to each other.

During formation of the torque arm 34, dimples 140, 142, 144, 146 are stamped or otherwise formed in the main body 134 and the cantilevered arm 136 of the torque arm 34. As shown, for example, with respect to dimples 140 and 142 in FIG. 15, each dimple 140, 142, 144, 146 forms a pit extending into the lower surface 130 of the torque arm 34 and forms a boss extending outwardly from the upper surface 132 of the torque arm 34. The bosses of dimples 140, 142, 144, 146 ride on the bottom surface 270 of the mounting plate 52 during reciprocal movement of the torque arm 34 with respect to the mounting plate 52 to aid in reducing friction between the two when the release mechanism 36 is in its normally biased position urging the latch 32 into engagement with the torque arm 34 and the torque arm 34 into engagement with the mounting plate 52.

The bosses of dimples 140, 142, 144, 146 also tend to aid in maintaining the substantially parallel relationship between upper surface 132 of the torque arm 34 and the bottom surface 270 of the mounting plate 52. Additionally, the bosses of the dimples 140, 142, 144, 146 help to maintain a horizontal separation between the torque arm 34 and the mounting plate 52 so that upper triangular cam 170 of the dual cam 46 engages only the torque arm 34 when the release mechanism 36 is in its normally biased position urging the latch 32 into engagement with the torque arm 34.

The main body 134 is formed to include a slide bushing-mounting hole 148 and a triangular cam-receiving aperture 150 to facilitate reciprocal forward and rearward movement of the torque plate 34 with respect to the mounting plate 52. The slide bushing-mounting hole 148 is sized to receive the body portion 212 of the slide bushing 209 of the release mechanism 36 therein to mount the torque arm 34 for rectilinear movement with respect to the mounting plate 52 as guided by the slide bushing 209 of the release mechanism 36 sliding within slot 306. The triangular cam-receiving aperture 150 is formed to engage surfaces of the triangular cam 170 of the dual cam 46 so that rotation of the dual cam 46, as well as the restorative force stored in the torque arm bias spring 42, induce reciprocal movement of the torque arm 34 forwardly and rearwardly with respect to the mounting plate 52.

The triangular cam-receiving aperture 150 includes a front wall 152 formed to include an arcuate cam follower surface 154, a substantially flat rear cam follower wall 156, a substantially flat cam follower side wall 158, a curved region 160 joining the flat rear wall 156 to the flat side wall 158, a curved region 162 joining the flat side wall 158 to the front wall 152 and an opposite side wall 164. The triangular cam 170 never engages the opposite side wall 164. Because the bias spring 42 is urging the torque arm 34 into its forward non-blocked position, the triangular cam 170 constantly engages the flat back wall 156 of the cam-receiving aperture 150. When the triangular cam 170 is in the non-blocked position, a flat side 200 of the triangular cam 170 contiguously engages and abuts the flat rear cam follower wall 156.

As the dual cam 46 rotates to the blocked and pulled-in position, a first rounded corner 202 of the triangular cam 170 urges the torque arm 34 rearwardly. During rearward movement of the torque arm 34, a second rounded corner 202 of the triangular cam 170, i.e. the rounded corner 202 rotating ahead of the first rounded corner 202, follows the curved region 160 and flat side wall 158 to inhibit lateral movement of the torque arm 34. As the torque arm 34 moves rearwardly, the slide bushing 209 of the release mechanism 36 received in the slide bushing-mounting hole 148 moves rearwardly in the slot 306 causing the latch 32 mounted on the release mechanism 36 to move rearwardly. During this rearward movement, the torque arm bias spring 42 is stretched to store a restorative force for urging torque arm 34 forwardly when the dual cam 46 rotates at the end of a self cleaning cycle.

When the cleaning cycle is complete and the dual cam 46 again begins to rotate, the second point 202 of the triangular cam 170 will follow the flat side wall 158 and the curved region 162 continuing to inhibit lateral movement of the torque arm 34. Typically, the second point 202 of the triangular cam 170 will not engage the arcuate cam follower surface 154 on the front wall 150 during normal mechanical movement. During normal operation, as the dual cam 46 rotates, the torque arm bias spring 42 urges the torque arm 34 forward to position the latch 32 in an unblocked, non-pulled-in, latched position.

The second point 202 of the triangular cam 170 may engage the arcuate cam follower surface 154 on the front wall 150 under certain failure conditions. For example, should the torque arm 34 become stuck when in the pulled-in state so that it does not freely move relative to the mounting plate 52, the second point 202 of the triangular cam 170 will contact and push against the arcuate cam follower surface 154 on the front wall 150 to aid the bias spring 42 in initiating forward movement of the torque arm 34 as the dual cam 46 is rotating to the non-pulled-in, non-blocked position.

The second point 202 of the triangular cam 170 also engages the arcuate follower surface 154 if the torque arm bias spring 42 breaks, becomes uncoupled from either the torque arm 34 or the mounting plate 52 or for some other reason fails to supply a restorative force to urge the torque arm 34 forward. Under those circumstances, the second point 202 of the triangular cam 170 will engage and push against the arcuate cam follower surface 154 on the front wall 150 to initiate forward movement of torque arm 34 as the dual cam 46 is rotating to the non-pulled-in, non-blocked position to position the latch 32 to allow the oven door 12 to be opened.

The cantilevered arm 136 extends from the main body 134 of the torque arm 34 a sufficient distance so that the distal end 166 of the cantilevered arm 136 is received in the channel 322 formed along the side 320 of the mounting plate 52. When the oven latch mechanism 30 is in the unlatched position, as shown for example in FIG. 2, and in the latched but not blocked or pulled-in position, as shown for example, in FIG. 3, the torque arm bias spring 42 urges the front wall of the cantilevered arm 136 near the distal end 166 into engagement with the front wall of the channel 322 During reciprocal movement of the torque arm 34, the distal end 166 of the torque arm 34 initially remains in contact with the front wall of the channel 322 and acts as a fulcrum of a lever with the force being exerted by the first rounded corner 202 of the triangular cam 170 on the rear follower wall 156 of the triangular cam-receiving opening 150 and a force being exerted by the spring 42 on the spring finger 138 of the cantilevered arm 136. As the triangular cam 170 rotates, the torque arm 34 moves rearwardly guided by the slide bushing 209 of the release mechanism 36 and the walls of the slot 306 formed in mounting plate 52. Torque arm 34 also pivots slightly about slide bushing 209 of the release mechanism 36 (as shown, for example, in FIG. 4 by the fact that back wall 156 of cam-receiving cavity is rotated to no longer be parallel with frame 14.) As shown, in FIG. 4, rearward movement of torque arm 34 induces rearward movement of latch 32 when the release mechanism 36 is in its normally biased position urging the latch 32 into engagement with the torque arm 34. As latch 32 moves rearwardly, engaging wall 124 of latching member 120 pulls against striker plate 28 to pull the oven door 12 toward the frame 14 compressing seal 24 between inner face 20 of oven door 12 and abutment surface 24 of frame 14.

Distal end 166 of cantilevered arm 136 of torque arm 34 may move reciprocally forwardly and rearwardly within the channel 322 as needed to compensate for variation in range assemblies regarding the door 12 meeting the front frame 14. Those skilled in the art will recognize that the seal 24 surrounding the oven compartment 16 need only be compressed by a small amount to seal the oven compartment 16 during self-cleaning cycles. However, due to manufacturing tolerances among components, the amount which the seal 24 can be compressed by the door 12 being pulled-in by latch 32 varies from oven to oven. Nevertheless, the amount of seal compression required remains substantially constant between ovens. As the seal 24 is compressed, the forward force exerted by the seal 24 on the oven door 12 increases thereby increasing the force exerted by the rear wall 156 of the cam-following opening 150 on the triangular cam 170. If the force exerted by the rear wall 156 of the cam-following opening 150 on the cam 170 were to become too great, the torque exerted on the motor and gear box 44 could result in motor stall. To avoid this, cantilevered arm 166 of torque arm 34 is permitted to slide rearwardly within channel 322 when the force exerted by the latch 32 on the door 12 (or conversely by the compressed seal 24 on the door 12) exceeds a predetermined force.

Those skilled in the art will recognize that the predetermined force at which the cantilevered arm 166 will move rearwardly within the channel 322 is dependent upon several variables including, but not limited to, the spring constant of the torque arm bias spring 42, the mounting locations 138, 324, 303 of the ends 41, 43 of the torque arm bias spring 42 on the torque arm 34 and on the mounting plate 52, respectively, the relationship between the moment arms created between the slide bushing-receiving aperture 148 and the contact point 202 of the triangular cam 170 on the cam-follower surface 150 and the mounting location 138 of the spring 42, and the frictional forces present between the torque arm 34 and the mounting plate 52. Those skilled in the art will recognize that the illustrated embodiment of the mounting plate 52 is formed with an alternative torque arm bias spring mounting location 303 on the top end of the actuator pin mounting bracket 300. Thus, mounting plate end 43 of torque arm bias spring 42 can be mounted to either the finger 324 or the alternative mounting location 303 on the top end of the actuator pin mounting bracket 300 to adjust the force at which the cantilevered arm 166 will move rearwardly within the channel 322 to relieve excess torque on the motor and gear box 44.

Thus, as shown, for example, in FIGS. 2-3, initially cantilevered arm 166 engages the front wall of channel 322 which acts as a fulcrum about which torque arm 34 pivots in response to rotation of cam 46. As cam 46 rotates, torque arm 34 moves rearwardly pulling latch 32 rearwardly into engagement with the oven door 12. Door 12 is pulled-in against seal 24 which exerts an outward force on door 12. When this outward force exceeds a predetermined amount, torque arm bias spring 42 can no longer maintain distal end 166 of cantilevered arm 136 in contact with the front wall of the channel 322. Torque arm bias spring 42 stretches a cantilevered arm 136 moves rearwardly in the channel 322, cam follower rear wall 150 slides along rounded corner 202 of triangular cam 170 to bring the back wall 150 closer to parallel with the frame 14 allowing the slide bushing 209 of the release mechanism 36, and the latch 32 coupled to the latch release shaft 207 of the release mechanism 36, to slide slightly forward in the slot 306. This forward movement of latch 32 relieves some of the force exerted by the compressed seal 24 on the inner face 20 of the door 12 and the torque exerted by the cam follower wall 150 on the triangular cam 170. Thus, cam 170 does not stall and can continue to rotate until the rounded corner 202 of triangular cam 170 is pointed rearwardly as shown, for example, in FIG. 6. When the cam 46 has reached the position shown in FIG. 6, i.e. rotated sixty degrees from the position shown in FIG. 2, motor and gearbox 44 stop until the end of the self-cleaning cycle.

As shown for example, in FIGS. 2-6, the dual cam 46 rotates in the direction of the arrow 234 which, from the bottom of the oven 10, is counterclockwise. Therefore in describing components of the dual cam 46, the terms “leading” and “trailing” will be used to describe various components with the understanding that “leading” refers to a component that is counterclockwise with respect to the “trailing” component.

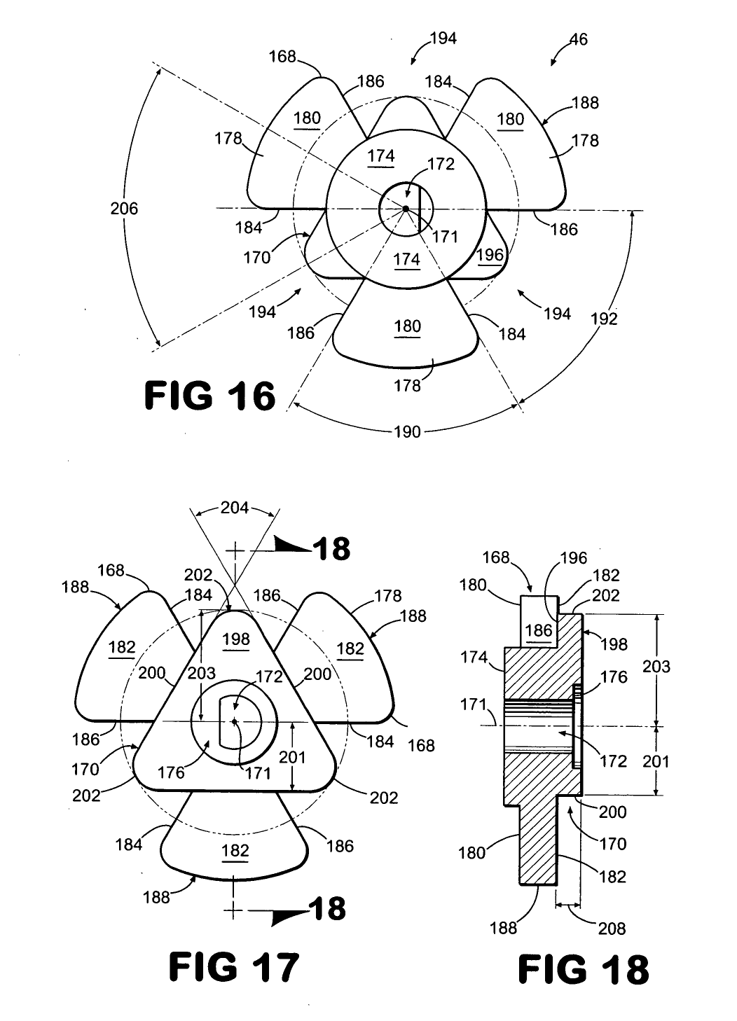

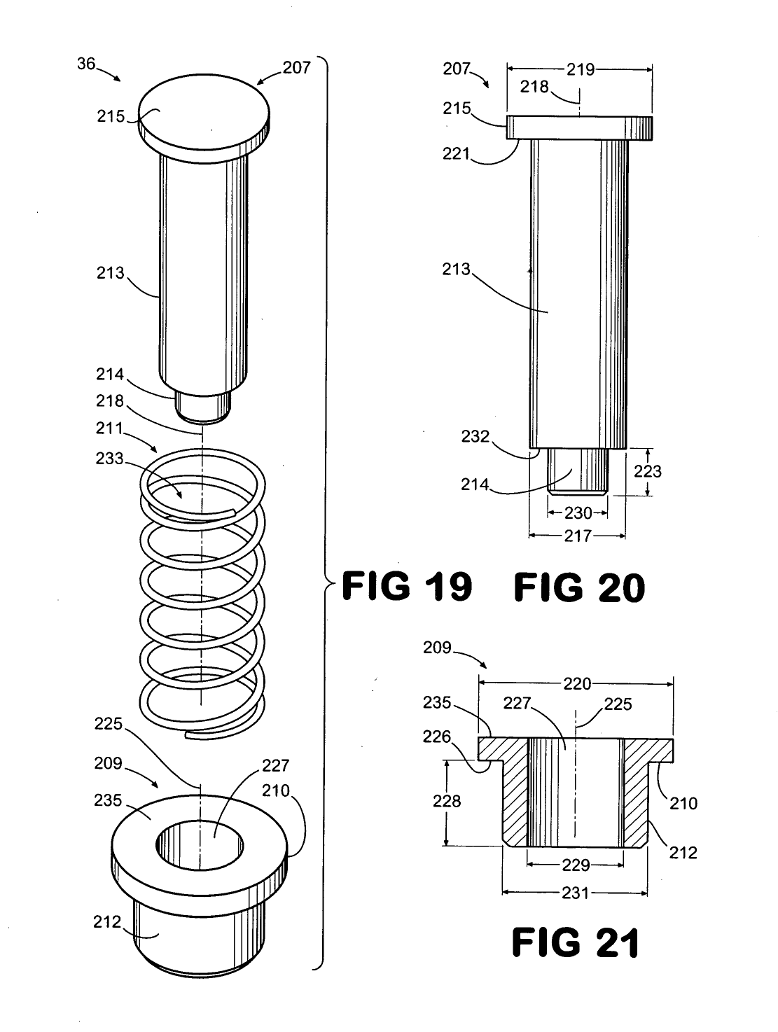

As shown, for example, in FIGS. 16-18, dual cam 46 includes a three lobed cam 168 and a triangular cam 170 formed symmetrically around an axis 171 extending through the D-shaped shaft-mounting bore 172 extending through an otherwise generally cylindrical body 174. The D-shaped motor driven shaft 250 is received in D-shaped mounting bore 172 to couple the dual cam 46 to the shaft 250. As shown, for example, in FIG. 18, a counterbore 176 is formed on the topside of the dual cam 46 to accommodate the shaft bearing 252 of the motor and gear box 44. While disclosed as a dual cam 46, separate triangular and three lobed cams fastly joined to the motor driven shaft 250 are within the scope of the disclosure.

As shown, for example, in FIG. 17, the three lobed cam 168 includes three indistinguishable lobes 178 extending radially from the axis 171 of the generally cylindrical body 174 of the dual cam 46. Each lobe 178 includes a bottom surface 180, a top surface 182, a leading side wall 184, a trailing side wall 186 and a camming surface 188. Camming surface 188 extends between the leading and the trailing side walls 184, 186. The leading side walls 184 and the trailing side walls 186 extend radially from the generally cylindrical body 174. The leading side wall 184 and trailing side wall 186 of each lobe 178 form an angle 190 of sixty degrees with respect to each other. Additionally, the trailing side wall 186 of each lobe 178 forms an angle 192 of sixty degrees with the leading side wall 184 of its trailing lobe 178, as shown, for example, in FIG. 16. Thus, the trailing side wall 186 of each lobe 178 and the leading side wall 184 of its trailing lobe 178 define a sixty degree void 194. Also the leading side wall 184 of a cam 178 and the trailing side wall 186 of its trailing cam 178 are diametrically opposed.

The camming surface 188 of each lobe 178 is generally arcuate shaped having a radius of curvature centered at the axis 171 of the mounting bore 172. However, at the junctures of the camming surface 188 with the leading side wall 184 and the trailing side wall 186, the camming surface 188 and the side walls 184, 186 are radiused. The radiused junctures of the camming surface 188 and the side walls 184, 186 facilitate smooth engagement and disengagement of the camming surface 188 with the follower surface 80 of the blocked member 76 of the latch 32 during rotation of the dual cam 46.

As shown for example, in FIGS. 17 and 18, triangular cam 170 includes a bottom surface 196, a top surface 198, three side walls 200 and three rounded corners 202. Triangular cam 170 is generally, except for the rounding of corners 202, in the shape of an equilateral triangle centered on the axis 171 of the shaft-mounting bore 172. Thus each side wall 200 forms an angle 204 of sixty degrees with its trailing side wall 200. As shown, for example, in FIG. 17, the three-lobed cam 168 and triangular cam are fastly joined in dual cam 46 so that a radial line extending through the apex of each rounded corner 202 forms an angle 206 of sixty degrees with a radial line extending through the center of the camming surface of its trailing lobe 178 of the three lobed cam 168.

The distance 201 from the axis 171 to the center of a side wall 200 of the triangular cam 170 is less than the distance 203 from the axis 171 to the center of a rounded corner 202 of the triangular cam 170. The disclosed oven lock mechanism 30 capitalizes on this difference between distances 203 and 201 to move the torque arm 34 and the latch 32 coupled thereto with the triangular cam 170 to snug the oven door 12 to the frame 14 and compress the seal or gasket 24 prior to initiation of a self-cleaning cycle. As the triangular cam 170 is rotated, and the point of engagement between the torque arm 34 and the triangular cam 170 changes from a side wall 200 to a rounded corner 202, the torque arm 34 moves rearwardly a distance equal to the difference between the distances 203 and 201.

As shown for example, in FIG. 18, the triangular cam 170 has a thickness 208 defined by the distance between its bottom surface 196 and its top surface 198. The bottom surface 196 of the triangular cam 170 and the top surface 182 of the three-lobed cam 168 are generally coplanar. The thickness 208 of the triangular cam 170 is such that when the dual cam 46 is mounted on the motor driven shaft 250 so that the top surface 198 of the triangular cam 170 is slightly below the bottom surface 270 of the mounting plate 52, then the bottom surface 196 of the triangular cam is slightly above the top surface 74 of the blockable arm 62 of the latch 32 when the release mechanism 36 is in its normally biased position urging the latch 32 into engagement with the torque arm 34. Thus, the triangular cam 170 interacts with the torque arm 34 without interfering with the latch 32, and the three-lobed cam 168 interacts with the blocked member 76 of the latch 32 without interfering with the torque arm 34 when the release mechanism 36 is in its normally biased position urging the latch 32 into engagement with the torque arm 34.

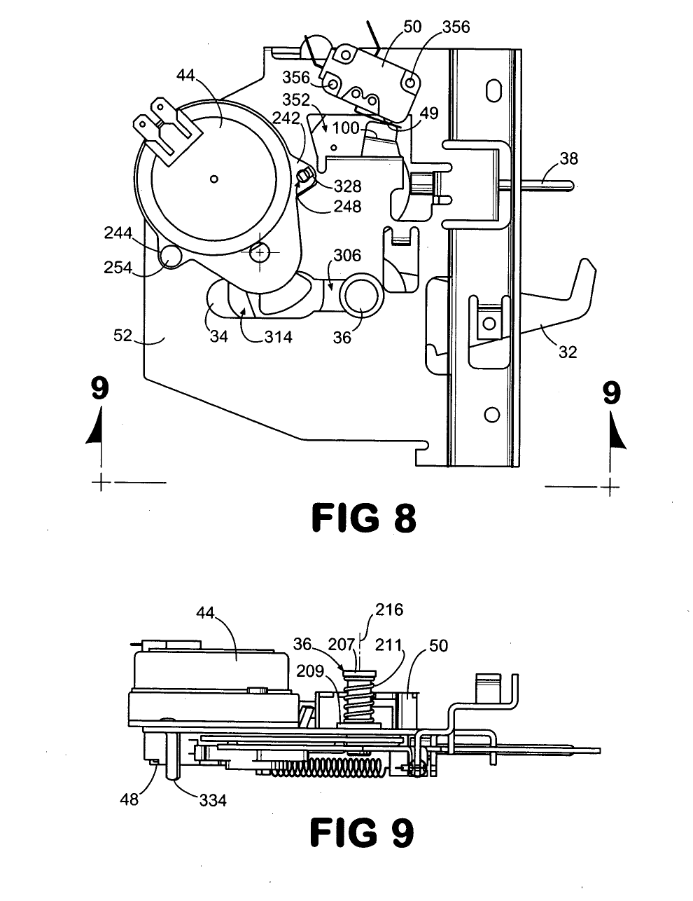

The motor and gear box 44 includes a motor, a gear box, mounting flanges 242, 244 (FIG. 8) formed to include mounting holes, a D-shaped shaft 250 (FIG. 2) and a shaft bearing. The motor is illustratively a synchronous induction AC high torque ODL class “F” motor. Motor and gear box 44 operate at 3 RPM in response to a 120 VAC, 60 Hz signal. Illustratively, motor has a 130 IN-OZ (0.92 Nm) minimum start and stall torque at 3 RPM over the operating range of 90V to 130V.

The mounting hole in mounting flange 242 is sized to receive a mounting pin 328 (FIG. 8) extending upwardly from the top surface 272 of the mounting plate 52 or a fastener. The mounting hole in mounting flange 244 is sized to receive a fastener such as a rivet 254 (FIG. 8) or a fastener which also extends through a corresponding motor mounting hole 330 on the mounting plate 52. When the motor and gear box 44 are mounted to the top surface 272 of the mounting plate 52, the motor driven D-shaped shaft 250 and the shaft bearing 252 are centered within the motor shaft-receiving hole 326 in the mounting plate 52. The dual cam 46 is mounted on the D-shaped shaft 250 with the D-shaped shaft 250 being received in the D-shaped motor shaft-mounting bore 172 and a portion of the shaft bearing being received in the counter bore 176. Thus, rotation of motor through the gear box drives the shaft 250 and the dual cam 46 attached thereto.

As shown, for example, in FIGS. 2, 22 and 23, the disclosed actuator pin 38 includes a head 256 and a shaft 258 formed concentrically about an axis 260. The head 256 of the actuator pin 38 includes a circular cam surface 262, a cylindrical wall 264 and an annular ring 266. The annular ring 266 extends inwardly from the cylindrical wall 264 in a plane perpendicular to the axis 260 to couple the head 256 to the shaft 258. The shaft 258 is generally cylindrical-shaped except that it includes a rounded end 268 for engaging the inner face 20 of the oven door 12.

The shaft 258 has a diameter slightly smaller than the diameter of the shaft-receiving apertures 298, 302 formed in the actuator-mounting brackets 294, 300 respectively. The cylindrical wall 264 has a diameter slightly large than the diameter of the shaft-receiving hole 300 in the actuator bracket 302 so that annular ring 266 engages the rear surface 304 of the bracket 300 to stop forward movement of the actuator pin 38, as shown, for example, in FIG. 2. The cam surface 262 engages the arcuate follower surface 98 of the follower arm 58 of the latch 32 when the release mechanism 36 is in its normally biased position urging the latch 32 into engagement with the torque arm 34 and, in response to an axial force exerted on the rounded end 268 of the shaft 258, urges the follower arm 58 to rotate about the pivot axis 216.

The illustrated mounting plate 52 is stamped and formed from a single sheet of metal such as nickel electroplated bright nickel. The mounting plate 52 includes essentially two regions, a substantially planar component mounting portion 274 and an offset oven mounting portion 276.

The oven mounting portion 276 includes an offset leg 278, a horizontal leg 280 and a lip 282. The offset leg 278 is coupled to the front of and extends upwardly from the component mounting portion 274. The horizontal leg 280 is coupled to and extends forwardly from the top of the offset leg 278. The offset leg 278 has a length that provides sufficient offset between the top 26 of the oven frame 14 and the bottom surface 270 of the component mounting portion 274 of the mounting plate 52 to facilitate mounting the latch 32, the torque arm 34 and the cam-actuated switch 48 to the bottom surface 270 of the component mounting portion 274. The horizontal leg 280 includes two mounting holes 286 through which fasteners (not shown) are received for mounting the mounting plate 52 to the top surface 26 of the oven frame 14. An L-shaped mounting leg 288 extends upwardly from the horizontal leg 280 for coupling to the underside of the cook top 18 of the oven 10. The upwardly-extending lip 282 is coupled to and extends upwardly from the front edge of the horizontal leg 280. The front surface 290 of upwardly-extending lip 282 contiguously engages the frame 14 of the oven 10 as shown, for example, in FIGS. 2-6. The upwardly-extending lip 282 is formed to include two mounting holes 292 through which fasteners (not shown) extend to mount the mounting plate 52 to the oven frame 14.

The component mounting portion 274 is substantially planar. A plurality of brackets, flanges, legs and fingers extend from the bottom surface 270 and the top surface 272 of the component mounting portion 274 to facilitate mounting various components to the mounting plate 52. The mounting plate 52 is also formed to include various apertures through which portions of mounted components extend.

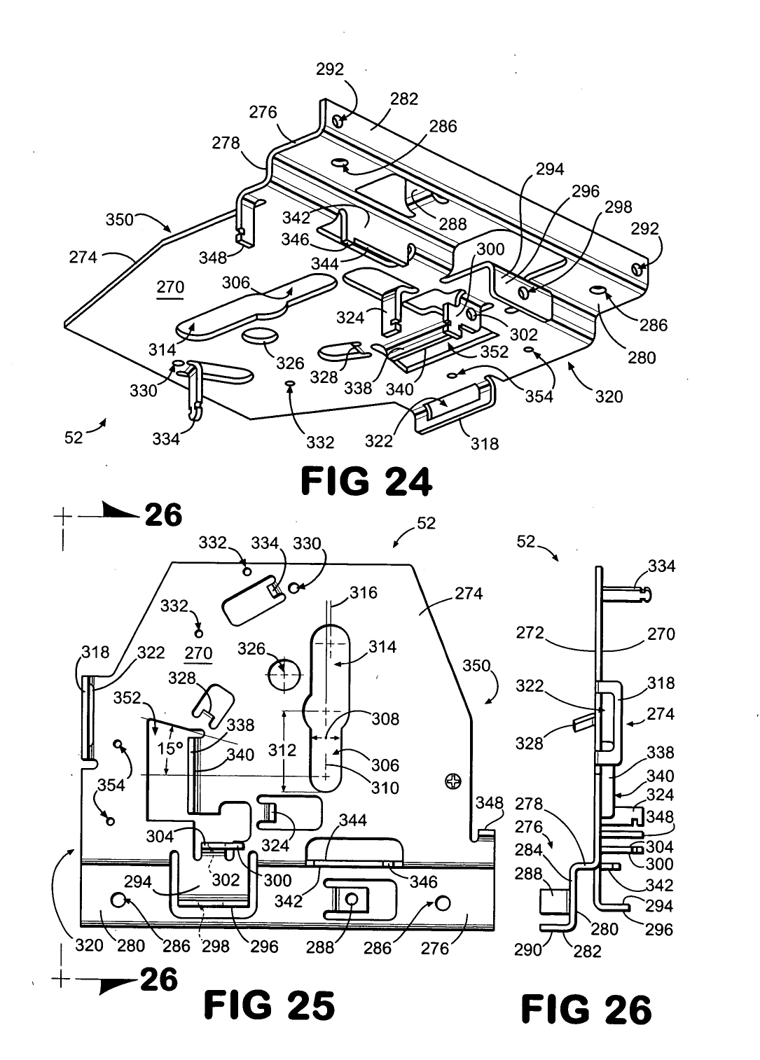

The mounting plate 52 is formed to facilitate mounting the actuator pin 38 thereto for reciprocal forward and rearward movement. An L-shaped actuator-mounting bracket 294 extends forwardly and downwardly from the front edge of the component mounting portion 274. The downwardly extending leg 296 of the L-shaped bracket 294 is formed to include a shaft-receiving aperture 298 extending between its front surface and rear surface. A rear actuator-mounting bracket 300 extends downwardly from the bottom surface 270 of the component mounting portion 274. Rear actuator-mounting bracket 300 is formed to include a shaft-receiving aperture 302 extending between its front surface and rear surface. As shown, for example, in FIGS. 2-6 and 24, the shaft-receiving apertures 298, 302 of the front and rear mounting brackets 294, 300, respectively, are aligned to permit the shaft 258 of the actuator pin 38 to reciprocate forwardly and rearwardly therethrough.

When the actuator pin 38 is mounted to the mounting plate 52, the shaft 258 of the actuator pin 38 is received in the shaft-receiving apertures 298, 302. The rear surface 304 of the rear actuator-mounting bracket 300 engages the annular wall 266 of the actuator pin head 256 to act as a stop against forward reciprocal movement.

The mounting plate 52 is also configured to facilitate mounting the torque arm 34 to the mounting plate 52 for forward and rearward reciprocal movement of the torque arm 34 with respect to the mounting plate 52. The mounting plate 52 is formed to include a slot 306 having a width 308 substantially equal to the diameter 231 of the body portion 212 of the slide bushing 209 of the release mechanism 36. Slot 306 has a longitudinal axis 310 about which it is symmetrically formed. Slot 306 has a length 312 greater than the sum of the diameter 231 of the body portion 212 of the slide bushing 209 of the release mechanism 36 and the difference between the distance 203 from the axis 171 of the dual cam 46 to the center of a rounded corner 202 of the triangular cam 170 and the distance 201 from the axis 171 of the dual cam 46 to the center of a side wall 200 of the triangular cam 170. The body portion 212 of the slide bushing 209 of the release mechanism 36 is received in the slot 306. The torque arm 34 and the latch 32 are mounted to the mounting plate 52 through the release mechanism 36. Portions of the annular face 226 of the head 210 of the slide bushing 209 of the release mechanism 36 engage the top surface 272 of the mounting plate 52 adjacent the slot 306. Thus, the torque arm 34 mounted on the release mechanism 36 reciprocates forwardly and rearwardly guided by the slot 306 with respect to the mounting plate 52.

An access slot 314 symmetrically formed about a longitudinal axis 316 off-set from the longitudinal axis 310 of slot 306 intersects with slot 306. The access slot 314 provides access to the portions of the cam 46 to facilitate unlocking the lock mechanism 30 in an alternate fashion in the event of failure.

A downwardly extending flange 318 stamped along a portion of the side 320 of the mounting plate 52 is formed to include an arm-receiving channel 322. The arm-receiving channel 322 receives the cantilevered arm 136 of the torque arm 34 and guides forward and rearward movement of the arm 136. The flange 318 in which the arm-receiving channel 322 is formed inhibits out of plane rotation of the torque arm 34 by engaging the bottom surface 130 of the cantilevered arm 136.

A torque arm bias spring anchor finger 324 extends downwardly from near the front edge of the component mounting portion 274 of the mounting plate 52. The mounting plate end 43 of the torque arm bias spring 42 is attached to the torque arm bias spring anchor finger 324. The torque arm end 41 of the torque arm bias spring 42 is attached to the spring anchor finger 138 on the torque arm 34. The torque arm bias spring 42 biases the torque arm 34 toward the front of the mounting plate 52 so that the slide bushing 209 of the release mechanism 36 is urged toward the front of the slot 306.

When the torque arm 34 is mounted to the mounting plate 52, the distal end 166 of the cantilevered arm 136 of the torque arm 34 is received in the arm-receiving channel 322 formed in the downwardly extending flange 318 along a portion of the side 320 of the mounting plate 52. The body portion 212 of the slide bushing 209 of the release mechanism 36 is received in the slot 306 and the slide bushing-mounting hole 148 of the torque arm 34 to couple the torque arm 34 to the mounting plate 52. The torque arm 34 and release mechanism 36 are configured to slide inwardly and outwardly guided by the slot 306. The torque arm bias spring 42 is coupled between the anchor finger 138 on the torque arm 34 and the anchor finger 324 on the mounting plate 52 to bias the torque arm 34 forward so that the slide bushing 209 of the release mechanism 36 is disposed near or in engagement with the front wall of the slot 306. When so mounted, the cam-receiving aperture 150 in the torque arm 34 is positioned under the motor shaft-receiving hole 326 in the mounting plate 52. This mounting arrangement facilitates actuation by the triangular cam 170 of the dual cam 46 of reciprocal movement of the torque arm 34 with respect to the mounting plate 52.

The mounting plate 52 is configured to facilitate mounting the motor and gearbox 44 and the dual cam 46 in a fixed position relative to the mounting plate 52. The motor and gearbox 44 and the cam 46 are mounted in a position so that the surfaces 200, 202 of the triangular cam 170 interact with surfaces 152, 154, 156, 158, 160, 162 of the cam-receiving aperture 150 of the torque arm 34 and the three lobed cam 168 interacts with the blocked member 76 of the latch 32 and a contact button 47 of the cam-actuated switch 48 when the release mechanism 36 is in its normally biased position urging the latch 32 into engagement with the torque arm 34. Thus, the mounting plate 52 includes a motor shaft-receiving hole 326 positioned to overlie the location at which the cam-receiving aperture 150 of the torque arm 34 is located when the torque arm 34 is mounted to the mounting plate 52. The motor shaft-receiving hole 326 is sized to permit the motor driven shaft 250 and shaft bearing to extend therethrough and rotate therein without engaging the walls of the hole 326.

A motor mount pin 328 sized to be received in a mounting hole on the flange 242 of the motor and gearbox 44 extends upwardly from the top surface 272 of the mounting plate 52. A motor mounting hole 330 extends through the mounting plate 52 through which a fastener, such as rivet 254, is received to mount the motor and gear box 44 to the mounting plate 52. The motor mounting hole 330 and the motor mount pin 328 are disposed on the mounting plate 52 to facilitate mounting motor and gearbox 44 to the mounting plate 52. When mounted to the mounting plate 52, the motor driven shaft 250 of the motor and gear box 44 is disposed in the center of the shaft-receiving hole 326. Dual cam 46 is mounted on the motor driven shaft 250 to interact with the torque arm 34 and the blocked member 76 of the latch 32 when the release mechanism 36 is in its normally biased position urging the latch 32 into engagement with the torque arm 34.

The mounting plate 52 is configured to facilitate mounting the cam-actuated switch 48 on the mounting plate 52 at a location in which the cam 46 engages the contact button 47 of the switch 48. The mounting plate 52 is formed to include two switch mounting holes 332 and a switch stop 334 that engages one end of switch 48. Switch stop 334 extends downwardly from the bottom surface 270 of component portion 274 of the mounting plate 52, as shown, for example, in FIGS. 26-28. Fasteners 336 (FIG. 2) extend through the switch mounting holes 332 and mounting holes (obscured by fasteners 336) on the cam-actuated switch 48 to secure the switch 48 to the mounting plate 52. The mounting holes 332 and the switch stop 334 are positioned and configured to place the contact button 47 of the cam-actuated switch 48 where it can be actuated by any of the lobes 178 of the three lobed cam 168 during rotation of the dual cam 46.

The mounting plate 52 is configured to facilitate mounting the latch 32 so that it can assume a non-latching, latching and pulled-in position. As has been previously stated, the latch 32 is not directly mounted for pivoting about a fixed pivot point relative to the mounting plate 52. Rather the latch 32 is mounted to pivot about a fixed pivot axis 216 relative to the torque arm 34 which pivot axis 216 moves reciprocally with respect to the mounting plate 52. This is possible because the latch 32 is mounted through the release mechanism 36 and torque arm 34 indirectly to the mounting plate 52.

To maintain portions of the latch 32 substantially parallel to both the mounting plate 52 and the torque arm 34, portions of the latch 32 engage various surfaces on the mounting plate 52 when the release mechanism 36 is in its normally biased position urging the latch 32 into engagement with the torque arm 34. Thus mounting plate 52 is formed to include a follower arm riding surface 338 on the bottom surface of a lip 340 extending downwardly from the bottom surface 270 of the mounting plate 52, as shown, for example, in FIGS. 2, 24-26. The mounting plate 52 is also formed to include a latch arm riding flange 342 extending downwardly from the bottom surface 270 of the mounting plate 52. Latch arm riding flange 342 includes a riding surface 344 and a stop 346 extending downwardly from the riding surface 344. When latch 32 is mounted to and suspended pivotally below the torque arm 34, the top surface of follower arm 58 rides on the follower arm riding surface 338 and the top surface of the latch arm 60 rides on the latch arm riding surface 344 when the release mechanism 36 is in its normally biased position urging the latch 32 into engagement with the torque arm 34. Rotation of the latch 32 in a counter-clockwise direction (as seen from above) is limited by the outside wall 116 of the latch arm 60 coming into engagement with the stop 346.

The mounting plate 52 is formed to ensure that the latch 32 is in a position in which the follower surface 98 of follower arm 58 is positioned to engage the cam surface 262 of the head 256 of actuator pin 38 when the release mechanism 36 is in its normally biased position urging the latch 32 into engagement with the torque arm 34. The mounting plate 52 is also formed to ensure that the blocked member 76 of the latch 32 is positioned below the triangular cam 170 of the dual cam 46 in a position to be engaged by a lobe 178 of the three-lobed cam 168 when the latch 32 is in the latched position and the release mechanism 36 is in its normally biased position urging the latch 32 into engagement with the torque arm 34. Thus, the blocked member 76 is positioned to be selectively blocked and non-blocked by one of the three lobes 178 of the dual cam 46 when the release mechanism 36 is in its normally biased position urging the latch 32 into engagement with the torque arm 34.

The mounting plate 52 includes a latch spring anchor finger 348 extending downwardly from the bottom surface 270 of one side 350 of the mounting plate 52. The mounting plate end 39 of latch bias spring 40 is coupled to the latch spring anchor finger 348 and the latch end 37 of the spring 40 is coupled to the bias spring anchor finger 128 on the latching arm 60 of the latch 32. The spring 40 biases the latch 32 toward the unlatched position.

The mounting plate 52 is formed to include an aperture 352 through which the offset switch actuator arm 100 of the follower arm 58 extends when the latch 32 is mounted on the release mechanism 36. Off set actuator arm 100 is an L-shaped arm that extends upwardly and beyond the end 102 of the follower arm 58 of the latch 32. L-shaped arm 100 includes an actuator surface 110 that selectively engages and actuates the contact button 49 of the latch-actuated switch 50. Two mounting holes 354 are formed adjacent aperture 352 for mounting switch 50 to the top surface 272 of the mounting plate 52. Fasteners 356 extend through the mounting holes 354 and mounting holes (obscured by fasteners 356) on the switch 50 to mount the switch 50 to the mounting plate 52.

The oven lock mechanism 30 disclosed herein utilizes door closure to position the latch 32 in a latched position and a motor to move a blocker into a position where movement of the latch 32 out of the latched position is blocked when a self-cleaning cycle is initiated and the release mechanism 36 is in its normally biased position urging the latch 32 into engagement with the torque arm 34. When the blocker is placed in such blocking position and the release mechanism 36 is in its normally biased position urging the latch 32 into engagement with the torque arm 34, any attempt to open the oven door 12 is unsuccessful since the blocker is positioned to prevent the latch 32, 432 from pivoting back to its unlatched position. The disclosed oven lock mechanism 30 uses a motor driven blocker that is rotated less than one hundred eighty degrees to move the blocker between the blocked and non-blocked positions. At the end of the self-cleaning cycle, a signal is sent to the motor and the cam 46 is rotated to a non-blocked position. The oven door 12 can then be opened. As the door 12 is pulled open, return springs drive the latch 32 to an unlatched position.

While the disclosed oven lock mechanism 30 uses the motor and gearbox 44 and a cam 46 to move the latch 32 once it is in the latched position to a latched and blocked snugged position, it is within the scope of the disclosure for the motor and gearbox 44 to actuate movement of the cam into a blocked position without inducing additional movement of the latch 32.

While the disclosed oven lock mechanism 30 uses closure of the oven door 12 to rotate latch 32 into a latched position, it is within the scope of the disclosure for the latch 32 to be moved to the latched position in other manners. For example, rotation of the cam 46 or movement of some other type of actuator can be used to move a latch 32 into the latched position within the scope of the disclosure. Additionally, the latch 32 can be biased to be urged toward the latched position and closure of the door can be utilized to momentarily move the latch 32 to an unlatched position.

While the disclosed oven lock mechanism 30 uses a unique pull-in mechanism to seal the oven door 12 during cleaning, it is within the scope of the disclosure for the release mechanism 36 to be utilized with an oven lock mechanism that does not include such a pull-in mechanism. Thus, the release mechanism 36 could be mounted in a fixed position relative to the oven, for example by mounting the bushing 209 in a fixed position relative to the mounting plate 52 and eliminating the torque arm 34 and the slide slot in the mounting plate 52 within the scope of the invention.

The release mechanism 36 disclosed herein moves the latch 32 to a position wherein it is no longer blocked from moving to an unlatched position by a blocker configured to inhibit movement of the latch 32 to the unlatched position when an oven cleaning cycle has been initiated. In the disclosed embodiment of the oven lock mechanism 36, both the actuator pin 38 and the cam 46 inhibit rotation of the latch 32 back to an unlatched position when the oven door 12 is closed. It is within the scope of the disclosure to eliminate the cam 46 and utilize a blocker that blocks the actuator pin 38 in the position that it assumes when the door is closed to block the latch 32 in the latched position when the release mechanism 36 is in its normally biased position urging the latch 32 into engagement with the torque arm 34. In such an oven lock mechanism, actuation of the release mechanism 36 would move the latch 32 to a position relative to the actuator pin 38 so that the latch 32 could rotate to an unlatched position without engaging the blocked actuator pin 38.

Although the invention has been described in detail with reference to a certain preferred embodiment, variations and modifications exist within the scope and spirit of the present invention as described and defined in the following claims.

What is claimed is:

1. An oven door lock mechanism for use with an oven having a door and a frame configured so that the door is adjacent the frame when the door is closed, the lock mechanism comprising:
a latch coupled to the frame for movement between an unlatched and latched position, the latch including a latching member extending beyond the frame for interacting with the door;
an actuator;
a blocker coupled to the actuator, the blocker and actuator cooperating to move the blocker between a non-blocking position wherein the latch is free to move between the latched and unlatched position and a blocking position wherein the blocker blocks movement of the latch from the latched position to the unlatched position; and
a release mechanism in operable engagement with the latch to move the latch, when the blocker is in the blocking position, to a disengaged position wherein the latch is disengaged from the blocker to enable the latch to move to the unlatched position.

2. The device of claim 1, wherein the latch is configured to pivot about a pivot axis between the latched and unlatched positions and the latch includes a follower surface offset from the pivot axis and further comprising an actuator pin movably supported by the frame, the actuator pin having an outer end extending beyond the frame for engaging the oven door upon closure and a cam end engaging the follower surface of the latch for rotating the latch into the latched position wherein the door is adapted to be captured by the latch.

3. The device of claim 2, wherein the latch is mounted to the frame for longitudinal reciprocal movement along the pivot axis and the release mechanism cooperates with the latch to move the latch longitudinally along the pivot axis.

4. The device of claim 3, wherein the release mechanism comprises a shaft coupled to the latch, the shaft being biased to maintain the latch in a position in which the blocker may engage the latch to block the latch when the release mechanism is not actuated.

5. The device of claim 4, wherein the shaft has a longitudinal axis defining the pivot axis and the release mechanism further comprises a bushing mounted to the shaft for reciprocal longitudinal movement relative to the shaft along the longitudinal axis.

6. The device of claim 1, wherein the blocker includes a cam, the cam being rotatable between the non-blocking position and the blocking position and wherein movement of the cam between the non-blocking position and the blocking position is accomplished by rotation of the cam by 60 degrees.

7. The device of claim 1, wherein the actuator includes an electromechanical actuator driven by a driver circuit and further comprising a switch controlling a the driver circuit and wherein movement of the latch between the unlatched and latched positions induces a change in state of the switch from a state in which the driver circuit is disabled to a state in which the driver circuit is enabled.

8. The device of claim 6 and further comprising a cam actuated switch and wherein rotation of the cam between the non-blocking position and the blocking position results in actuation of the switch.

9. The device of claim 8 wherein the cam includes a three lobed cam having three lobes and each two lobes defining a void therebetween.

10. The device of claim 9 wherein the latch includes a blockable arm having a blocked member offset from the pivot axis and wherein the blocked member is disposed at least partially within one of the voids between two lobes of the cam when the latch is in the unlatched position.

11. An oven lock mechanism for use with an oven having a door and a frame surrounding a cooking chamber having an opening selectively closed by engagement of the door with the frame, the lock mechanism comprising:
a mounting plate mounted to the frame;
a latch mounted to the mounting plate for movement about a pivot axis and rotatable about the pivot axis between an unlatched and latched position, the latch including a follower surface offset from the pivot axis;
an actuator pin movably supported by the mounting plate, the actuator pin having an outer end extending beyond the mounting plate for engaging the oven door upon closure and a cam end engaging the follower surface for rotating the latch into the latched position wherein the door is adapted to be captured by the latch;
a blocker selectably moveable into a blocking position when the latch is in a latched position for interfering with the rotation of the latch such that the latch is blocked into the latched position for locking the oven door in a closed position;
an electromechanical actuator mounted to the mounting plate, the actuator urging the blocker into the blocking position when actuated; and
a release mechanism in operable engagement with the latch to move the latch, when the blocker is in the blocking position, to a disengaged position wherein the latch is disengaged from the blocker to enable the latch to move to the unlatched position.

12. The device of claim 11 wherein the actuator is a motor.

13. The device of claim 12 wherein the blocker is rotated sixty degrees or less to move between a non-blocking position wherein the blocker does not inhibit movement of the latch and the blocking position.

14. The device of claim 11, wherein the latch is configured to pivot about a pivot axis between the latched and unlatched positions and the latch includes a follower surface offset from the pivot axis and further comprising an actuator pin movably supported by the mounting plate, the actuator pin having an outer end extending beyond the frame for engaging the oven door upon closure and a cam end engaging the follower surface of the latch for rotating the latch into the latched position wherein the door is adapted to be captured by the latch.

15. The device of claim 14, wherein the latch is mounted to the mounting plate for longitudinal reciprocal movement along the pivot axis and the release mechanism when actuated cooperates with the latch to move the latch longitudinally along the pivot axis.

16. The device of claim 15, wherein the release mechanism comprises a shaft coupled to the latch, the shaft being biased to maintain the latch in a position in which the blocker may engage the latch to block the latch when the release mechanism is not actuated.

17. The device of claim 16, wherein the shaft has a longitudinal axis defining the pivot axis and the release mechanism further comprises a bushing mounted to the shaft for reciprocal longitudinal movement relative to the shaft along the longitudinal axis.

18. An oven lock mechanism for use with a self-cleaning oven having a door for selectively closing an opening of a cooking compartment surrounded by a frame and a compressible seal, the oven lock mechanism comprising:
a mounting plate coupled to the frame near the oven compartment opening;
a latch pivotably mounted to the mounting plate about a pivot axis and rotatable between an unlatched and latched position, the latch including a follower surface offset from the pivot axis;
a blockable member mounted for movement relative to the mounting plate, the blockable member being coupled to the latch so that when movement of the blockable member is blocked, movement of the latch from the latched to the unlatched position is inhibited;
an actuator pin movably supported by the mounting plate, the actuator pin having an outer end extending beyond the mounting plate for engaging the oven door upon closure and a cam end engaging the follower surface for rotating the latch into the latched position wherein the door is adapted to be captured by the latch;
a blocker mounted for movement relative to the mounting plate to selectively block and unblock the blockable member;
a motor coupled to the mounting plate, the motor when actuated moving the blocker; and
a release mechanism in operable engagement with the latch to move the latch, when the blocker is in the blocking position, to a disengaged position wherein the blockable member is disengaged from the blocker to enable the latch to move to the unlatched position.

19. The device of claim 18, wherein the latch is mounted to the mounting plate for longitudinal reciprocal movement along the pivot axis and the release mechanism when actuated cooperates with the latch to move the latch longitudinally along the pivot axis.

20. The device of claim 19, wherein the release mechanism comprises a shaft coupled to the latch, the shaft being biased to maintain the latch in a position in which the blocker may engage the latch to block the latch when the release mechanism is not actuated.
